(19) United States
(12) Patent Application Publication
(10) Pub. No.: US 2011/0307440 A1
(43) Pub. Date: Dec. 15, 2011

(54) METHOD FOR THE FULLY MODIFIABLE FRAMEWORK DISTRIBUTION OF DATA IN A DATA WAREHOUSE TAKING ACCOUNT OF THE PRELIMINARY ETYMOLOGICAL SEPARATION OF SAID DATA

(75) Inventor: Borys Evgenijovich Panchenko, Kiev (UA)

(73) Assignee: Olga Perevozchikova, Kyiv (UA)

(21) Appl. No.: 13/215,250

(22) Filed: Aug. 23, 2011

Related U.S. Application Data
(63) Continuation-in-part of application No. PCT/UA2010/000007, filed on Feb. 25, 2010.

(30) Foreign Application Priority Data
Mar. 2, 2009 (UA) 200901773
Feb. 17, 2010 (UA) 201001694

(51) Int. Cl. G06F 17/30

(52) U.S. Cl. 707/600; 707/E17.009

(57) ABSTRACT

Method for the fully modifiable framework distribution of data in a data warehouse taking account of the preliminary etymological separation of said data is based on the framework model of data. It is about the totality of the entity-objects, that relate to a particular abstract domains, is distributed into five groups in an automated way: atomic, composite and weak entity-objects, as well as artifacts i.e. entity-copies the data of which are conventionally placed in warehouse, and a group of indefinite entity-objects, the semantics of which is the subject to further specification. The method provides for the option of replenishment of the algorithms groups and criteria for the separation, each of which allows for a more accurate classification of a particular entity-object to the above-mentioned groups. And their using consistently makes it possible to speed up the process and reduce the fifth group—the group of indefinite entity-objects, which have contradictory characteristics—they can be equally assigned to different groups. A few algorithms were shown. This is an algorithm based on using the dictionary of entity-objects, which is available in public networks and is constantly replenished, and on functional dependencies between the data from the entity-objects, which allows us to compare the entity-objects with each other; an algorithm for tracking some repeating entity-objects in binary pairs, the algorithm of the statistic analysis of the determinized or multi-valued dependencies, as well as the algorithms of successive approximations modifications on the connections' framework-template. This pre-separation of the entity objects set in the abstract domains makes it possible to simultaneously use both the relational properties and, for example, object-oriented model of data distribution. This provides the option to account for some artifacts, for which multiple domains masks are formed in the warehouse, each of which is assigned an identification key corresponding to its structure. Effectuating the Cartesian products of masks among themselves on an “each on each” principle, a complete set of composite entity objects is obtained. After that, they set aside some semantically incompatible ones from the obtained tables—for example, the result of multiplying two weak entity-objects that have a common ancestor. Thus, a logical and physical data schemas, which are equivalent to each other. This enables using of relational capabilities in a physically distributed data warehouse separated onto different servers. The method also solves the issue of standardization of data warehouse schemes creation.

This Patent Application is a Continuation-In-Part application of International Application PCT/UA2010/000007 filed on Feb. 25, 2010, now pending. This application claims the priority benefit of Ukrainian Application 200901773 filed on Mar. 2, 2009 and Ukrainian Application 201001694 filed on Feb. 17, 2010.

The invention relates to information technology and can be used to construct speech recognition devices, translating devices, expert systems, automated audit systems for verification of correct performance of information suits in service, as well as computer-aided design of data warehouses for arbitrary abstract domains (abstract domains of any size and any structure, named “abstract domains” hereafter) with the ability to flexibly modify the warehouse scheme.

Here, the term “datum” refers to material electric charge of certain volume or material electromagnetic field of certain strength. Data manipulation means a controlled material impact on the respective material medium (e.g., other electromagnetic field), which in turn controls the data, resulting in placing them into a digital memory in a particular way—that is, material medium as well, which can be built according to typical principles: as a set of capacitors, triggers, magnetic layers, etc. Therefore, due to the fact that the data manipulation is “a material affecting a material”, applications describing this process are filed under the G06F class in the international patent classification.

Widely known are traditional methods of data distribution based on classical techniques (Codd E. F., A Relational Model of Data for Large Shared Data Banks—Comm. ACM, 13, 6 (jun), 1970, p. 377-387; Codd E. F., Normalised Data Base Struchture: a Brief Tutorial.—Proc. ACM, SIGFIDET, 1971, Workshop, San Diego, Calif., November 1971, p. 1-18, Maier D. Why isn't there an object-oriented data model?—Proceedings IFIP 11th World Computer Conference, San Francisco, Calif., August-September, 1989, Chen P P The Entity-Relationship Model: toward a unified view of data.—ACM Trans. on Data base systems, 1:1, 1976, h. 9-36). These methods have a major drawback—they do not solve the problem of obtaining a universal and flexible scheme of a warehouse and create the warehouse dependant on the initial semantics of the abstract domains and do not address the issue of flexible modifiability of the warehouse scheme in the process of further exploitation. Regarding the use of the ontology technique, i.e. construction of parameterized thesauruses of abstract domains, a significant survey of techniques and strategies is outlined in the publication “Ontology Change: Classification and Survey” (“Ontology Change: Classification and Survey”. Flouris Giorgos, Monakenates Dimitris, Kondylakis Haridimos, Plexousakis Dimitris, Antoniou Griroris; Knowl. Eng. Rev., 2008, 23, No 2, c. 117-152, Bibl. 144). Nevertheless, all these approaches do not address the issue of constructing a method which could allow the automated creation of flexible, quickly modifiable schemes of a warehouse, based on a spoken or written description of the abstract domains in a natural language.

Close to the method described in this application is a method of using preliminary formal description of abstract domains, which is used in the widely known WordNet ontology (Soloviev V. D., Dobrov B. V., Ivanov V. V., Lukashevich, N. V., Ontologies and Thesauri MSU, Moscow, 2006). However, this ontology also has a significant drawback—it lacks a universal factor allowing you to organize the semantics of the entity-objects, i.e., nouns from the description of abstract domains. It also lacks any approach that would probably minimize the number of basic categories which allow you to perform automated separation of the entity-objects among a large number of synonyms and terms in the abstract domains' initial description stream.

Nevertheless, although all these systems have some above-mentioned deficiencies, their existence proves it possible to implement the method described in this application. These known products and tools implemented in the above-mentioned abstract domains are significantly different in principles of construction and approaches to data manipulation; they also differ from the method in this application. However, these significant differences do not diminish the method's feasibility and do not affect the purpose of the invention.

The invention is aimed to create a generalized universally flexible way of data distribution into a warehouse, which would model arbitrary abstract domains and allow using a uniform procedure for automating the process of creating the scheme of such a warehouse. This procedure should provide complete modifiability to the warehouse scheme, i.e. minimize the number of operations needed for a modification and allow to make changes in dynamic mode—while the warehouse is being used. It should also optimize integration of different warehouses, constructed in accordance with this method into a single information system.

This problem is solved in the following sequence: at the first stage an automated etymological data separation is performed, and at the second stage an automated framework distribution of data in the warehouse is carried out in accordance with the results of the etymological separation.

The method of data distribution in a digital warehouse closest to the one in this proposal (the prototype method) is the method whose scheme is constructed in accordance with the Cartesian multiplication of entity-objects' surrogate keys (Panchenko B. E., Method of data distribution into a computer warehouse to ensure modifiability of the structure, Ukrainian Patent No. 63036 of 15 Jan. 2004). In accordance with this model and using the multiplication of Cartesian sets of entity-objects' surrogate keys, the scheme of a warehouse is formed by a set of relational tables filled with the entity-objects' data attributes and relations attributes. Nevertheless, this method has a flaw—it does not allow automatic extraction of various entity-objects' masked semantics from the initial abstract domains description stream.

All terms and concepts used in this application which are not commonly known, are listed in a separate thesaurus placed at the end of the description.

All the entity-objects in the proposal are divided into five categories. The First category comprises atomic entity-objects, which are called base entity-objects in some data models. The second category comprises weak entity-objects that are functionally dependent on the atomic ones and have the same name in data models. Moreover, this dependence can be either only at the level of identification of weak attributes, or at the level of existence of dependent weak entity-objects. Nevertheless, there is an exception to it. For certain abstract domains, some weak entity-objects can be forced to be atomic ones. In this case, a user designates an entity-object as the last member in its hierarchy. And then it is artificially assigned an identifier that uniquely identifies all the attributes. Such exceptions are the specific boundary of the abstract domains where the user is aware that this boundary would not expand during a considerable period of operation time of the data storage being created or inspected by the user. Nevertheless, these are the exceptions that make it impossible to modify the warehouse scheme without making modifications to its operation itself—both while it is working, or after it has been shut down.

The third category contains composite posts-relational entity-objects, which are also called multilateral in data models.

Thus, in this method, the entity-objects are formed as follows: the weak ones are generated on the base of the atomic ones, i.e. the weak ones are functionally dependent on the base ones. Then the composite post-relational entity-objects are created on the set of atomic and weak entity-objects thanks to the formation of various relations among them. Moreover, the described formation of the weak and the composite entity-objects is masked by the parts of speech—nouns, verbal nouns, various terms that correspond to them, categories that generalize them, etc. This is what makes automated separation important today. The vast majority of composite entity-objects are usually mistakenly classified as weak or even atomic ones, which in turn leads to increased rigidity of a system and renders its flexible development impossible without radical reworking.

The fourth category includes artifacts, i.e. entity-copies, whose data will be conditionally placed into warehouse at a user's discretion. For instance, any document the abstract domains users create for the purpose of copying certain attributes of certain entity-objects can be considered an artifact. Not just copying the attributes of a specific entity-object, but also combining several attributes of different entity-objects in this newly formed entity-object.

Artifacts are usually “post-effect” entity-objects. Therefore, by registering them in the system operating a warehouse, a user faces considerable duplication of data. This, in turn, leads to the need of superfluous monitoring of the redundant data integrity. The exception is the set of artificial entity-objects, each of which only combines a certain part of the attributes of another, more general non-artificial entity-object. Moreover, the combination of the sets of attributes of each artificial entity-object is strictly identical to the set of all the attributes of the general, non-artificial entity-object. I.e. none of the artificial entity-objects has any attribute, which is common for even two artificial entity-objects. And also there is no attribute in common non-artificial entity-object for which there is no copy in the set of artificial entity-objects. Thus, this set of artificial entity-objects is also classified as an “artifact” by the method. Nevertheless, monitoring the integrity of such duplicated data is simplified. Let's note in advance that such artifacts are used as entity-objects' masks at the second stage of the method.

And at the end of the list is a group of indeterminate entity-objects whose semantics is to be further clarified.

Some examples of atomic entity-objects are: “person”, “universe”, “dog”, “cat”, etc. Moreover, putting these entity-objects to some further categories—the so-called classification of atomic entity-objects—is an artificial semantic user's superstructure which masks the content of an entity-object. Some examples of weak entity-objects are “unit”, “department”, “laboratory”, “apartment”; each of these entity-objects is not self-sufficient. And in some abstract domains it is functionally dependent on “older” entity-objects, its ancestors. Examples of composite entity-objects are event-based entity-objects: “exam”, “concert”, “exhibition”, “agreement”, “meeting”, etc. Their content is a “product” of equal cooperation of several other entity-objects. Examples of artifacts are “invoice”, “bill” (to be paid at a restaurant or for other services, etc.), “formal note”, etc.

The method in this application is constructed in accordance with the theory of the abstract domains' framework model (Panchenko B. E., On the design of a universal logical data model//Bulletin of Sumy State University—Sumy, 2009.—“Tech.” series, Vol. 2.—pp. 60-66 and Panchenko B. E., Pysanko I. N., Properties of Relational framework on a set of semantically atomic predicates, “Cybernetics and Systems Analysis,—Kiev, 2009.—No 6.-C. 120-129). In this model, the main tool for analyzing the abstract domains is multiplace semantically atomic predicates based on a single factor—the origin of the entity-object. Not the origin of the term but the origin of the content encoded by the term. This model uses the fact that abstract domains always have a limited base set of entity-objects, which incorporates only atomic and weak entity-objects. And all the other entity-objects (almost always dominating in number) are synthesized from this set due to the framework of relations, i.e. the power set of all subsets of entity-objects' relations from the base set. I.e., the other entity-objects are the result of the abstract domains' operation.

So, in general terms the first stage of the method's algorithm is reduced to the following steps.

1. Automated removal of the base set of entity-objects, which in the abstract domains' initial description stream can be masked by a variety of terms, categories, auxiliary nouns, synonyms, etc. The base set is separated from the artifacts, indeterminate and composite entity-objects. And this is done by successive approximations, where each next step makes each previous data set more precise, due to certain logical and mathematical criteria. For this purpose the method involves sequential or parallel execution of automated logical comparison of each entity-object with every other entity-object. The number of subordinate logical procedures and comparison criteria is not limited—this group can be put into an external replenishable library.

2. Synthesis of framework reference composite entity-objects. This involves the construction of a framework model from the base set using powerset of relations on the “each with each” principle.

3. The final separation of the composite entity-objects through the procedures of statistical comparison of reference composite entity-objects obtained on the framework model—and the composite entity-objects separated from the initial stream at the final stage. After all, it is the composite entity-objects in the abstract domains that are masked the most. And they have the most controversial origin of the content.

4. Recommending the Probable Etymologies Dictionary administration of the possibility of replenishing its resources with some new groups of entity-objects, if no contradictions are found in the final groups.

Thus, on closer inspection, the first stage of the method—which is the method of preliminary framework data separation before their modifiable placing in a warehouse or further processing—lies in the following: the data being placed are automatically distributed into the above mentioned five groups according to the results of automated logic and statistical analysis of vocal, textual or schematic description of certain abstract domains has entity-objects that combine each such group. And such data group has a common set of characteristics satisfying the general predicate. The groups of entity-objects have either peer-to-peer or hierarchical relations.

The method provides that the description of abstract domains to undergo automated data-logical modeling, must be expressed in the following linguistic form: the input unit is an atomic sentence (referred to as just “sentence” hereafter) containing a pair of entity-objects that are coded with nouns having unique spelling. It is assumed that repeated nouns represent the same entity-object. Therefore, such repetition within a single sentence would mean a trivial pair, i.e. the one only carrying information about the existence of the entity-object in abstract domains without linking it to the others. It is a declaration to be used during the next steps of the analysis.

A verb with a unique spelling represents only binary relationship between them, i.e. the relationship between a pair of entity-objects of the same sentence. It is assumed that verbs repeated in different sentences mean the same class of relationship. Therefore, the main mission of an atomic sentence is to inform about the presence of entity-objects in particular abstract domains and to declare the pair's relationship class. Sentences comprising more than two entity-objects are composite. They are subject to automatic decomposition. Any known algorithm for decomposing composite sentences can be used for this purpose, e.g. the one used in any compiler for parsing lines. Nevertheless, sometimes composite sentences cannot be automatically decomposed to a binary form because of technological reasons (e.g. because of the absence of a rigid structure combining it into one composite sentence). These sentences are extracted from the initial description stream and set aside into a description fragment subject to further clarification.

The method does not have an upper limit of the number of sentences. A lower limit is defined by abstract domains' content. Nevertheless a formal preliminary analysis should be performed to ensure that each declared entity-object has at least one relation with some other entity-object.

So the first step of the method is inputting an audio voice signal in real time, or a file with a pre-recorded voice signal, dictated in a natural language and describing abstract domains. The description can be prepared as a text file formed as a natural language text, or as a file generated in the language of sequential schemes or graphs that correspond to the description of abstract domains. This can also be a sequence of files from data warehouses that are already in operation in order to study the possible contradictions in the data schemes and predict the modification costs during further development of the system. And in order to convert the abstract domains' initial description file (in the language of sequential schemes or graphs) into a stream of words, the method requires that each graph figure in the scheme—for example, a rectangle—be matched to a noun, and each arc of the graph (indicated in the scheme with a straight or curved line binding these rectangles) be matched to a verb. The method involves a separate procedure for strict extraction from the initial stream of the pairs of entity-objects and their relations, as well as designating them as nouns and verbs, i.e. processing graph ER-schemes under the restrictions of unique entity-objects' spelling. A similar procedure is used when converting files from operating data warehouses. These types of files are also input.

For further analysis, each stream can be used not only on its own, but also in accordance with one another. The recognition of separate words in an audio stream or transformation of collections of schemes or file structures of data warehouses into a verbal stream, and after that—placing all obtained words in memory, are carried out by means of familiar procedures.

During the further step every word is analyzed one by one on the principle of successive approximations, and the user can intervene into the process as the method can work in an interactive mode; this allows dynamically taking into consideration any additional information about the data from the abstract domains. Unstructured cumulative initial stream formed by the user to describe abstract domains is converted in memory into a stream having the above-mentioned specialized form and structure, where the technological unit of analysis is one atomic sentence.

During the further implementation of the method a portion of memory is allocated where the structured cell identifiers are stored. The structure of each identifier is neither arbitrary nor specified by the user nor obtained in any other way, but is strictly correspondent to each entity-object content's probable semantic structure. This structure corresponds to the structure of the predicate forming the entity-object. For automated extraction of a masked structure, logical and mathematical criteria are used. These criteria are constructed in accordance with patterns identified in abstract domains using the framework data model. These criteria are based on a single generalized factor—the entity-object content's origin, i.e. its content's etymology (referred to as “etymology” hereafter).

Thus, the method in this application uses the fact that all other factors characterizing the semantics of any entity-object in the abstract domains are functionally dependent on the etymology. The etymology, in turn, is described by the mathematical logic of predicates. It has the following general scheme in the form of a string-based structured identifier:

X₁^{m}^{₁}+X₂^{m}^{₂}+X₃^{m}^{₃}+ . . . +Xₖ^{m}^{_{k,}}

where each member Xₖ_{ᵢ}^{m}^{ₖ} is a separated identifier of i-th entity-object's origin fact, kᵢ is the member number of i-th entity-object identifier (subscript), mₖ is the number of the corresponding generating entity-object from the entity-objects' base set, the combined group of atomic and weak entity-objects (superscript); each mₖ can only have a value from the set {1, 2, . . . , N₀, . . . , N}, where N₀ is the total number of atomic entity-objects, N is the total number of atomic and weak entities, i is the number of an arbitrary entity-object in the abstract domains. And in the case of an exhaustive set of relationships i={1, 2, . . . , N₀, . . . , N, (N+1), . . . , (2^{N}−1)}. The “plus” sign in the general form of the etymology scheme means string concatenation. For atomic entity-objects the etymology is only one member Xⁱ, where m=i. Thus an atomic entity-object generates itself. The method in this application assigns atomic entity-objects initial numbers, i.e. i=i=1, N₀. For weak entity-objects etymology is the above-mentioned sum of the string members, where each member Xₖ_{ᵢ}^{m}^{ₖ} strictly corresponds to its number kᵢ. Thus the sequence of members strictly corresponds to the sequence of dependencies of each subsequent member on the previous one. This in turn corresponds to the sequence in which each previous weak entity-object (up to the highest atomic entity-object) synthesizes the following weak one.

For composite entity-objects the etymology is the above-mentioned sum of string members, where the position of each member Xₖ_{ᵢ}^{m}^{ₖ} is not strict, i.e. the sequence order does not matter. Nevertheless, the overall set of members strictly corresponds to the set of generating entity-objects. Thus, in general case for any entity-object the structured cell identifier is the cumulative string of characters or digits, each member of which has the minimum sufficient string size. Such an identifier, for example, in the relational data model can be used as a minimally sufficient surrogate key of a relational table, combining in one relation all the properties of a particular entity-object. Its attributes are the arguments of the entity-object's generating multiplace predicate. And the number of places in the predicate is identical to the number of entity-object's attributes. That is, since an entity-object can have any number of attributes, the forming predicates are multiplace ones. But this does not affect the predicate's functional part structure, hence this does not affect the cell identifier structure. Each member in the entity-object's etymology means a relationship with other entity-objects which took part in the generation of a particular entity-object if the latter represents a weak, or composite, i.e. post-relational entity-object. Thus, each member Xₖ_{ᵢ}^{m}^{ₖ} of the cell identifier is constructed in strict accordance with the entity-objects' content etymology from the abstract domains description.

Each abstract domains' entity-object can correspond to either an atomic predicate being unary in the functional part, but multiplace in the argument part and hence having a unary identifier Xⁱ, or to a predicate being composite in the functional part and multiplace in the argument part and hence having a composite identifier ΣXₖ_{ᵢ}^{m}^{ₖ}, where the summation is performed over kᵢ, kᵢ=1, Kᵢ, since the identifier has the above-mentioned general structure. The predicate's composite functional part is the result of a conjunction of unary predicates, corresponding to the string concatenation of the identifiers members' data sets, i.e. adding rows. Moreover, the total number of members Kᵢ represents the arity of the generating multiplace predicate's functional part, which can generally equal 2, 3, . . . , 10, and so on. For an atomic entity-object it always equals 1.

Now the identified warehouse cells can contain the entity-objects' groups of attributes, such as their names and a group of other properties or characteristics being the arguments of the corresponding atomic or composite multiplace predicates. Unary warehouse cell identifiers strictly correspond to atomic entity-objects, while the composite cell identifiers strictly correspond to weak and composite entity-objects.

During the further steps, each entity-object from each sentence is sequentially or simultaneously (i.e. parallely) compared in memory with each other entity-object. This procedure fulfills some subordinate ways of automated logical extraction of each entity-object's masked etymology, and hence its content's semantic structure. The result of its performance is a logical separation, that is, each cell (storing each entity-object attributes' data from the initial stream) is given the respective preliminary structurized cell identifiers. The entity-objects are being regrouped into the above-mentioned and separately placed groups in the warehouse. In this case, restoration of the structure of each member in the etymology of the entity-objects at this stage is carried out through an automated logical analysis of nouns and verbs, i.e., through the analysis of the entity-objects' and relations' contents without taking into account sets of specific values of the entity-objects specific attributes. The analysis is based on a comparison of the contents of entity-objects to each other on an “each with each” principle using a dictionary of possible etymologies of the entity-objects contents which can be placed also in the public domain and be continually refined and updated automatically. In this dictionary every noun is pre-assigned the most probable structure of the functional part of the predicate specifying the noun. That is the etymology of its contents, defined either hypothetically or obtained through research and recognized by a user. The degree of this probability depends on the specifics of abstract domains. Thus, on this stage a correspondence between the words from the initial stream and the words existing in the dictionary is established. The result of this comparison is a first approximation of the desired separation of the entity-objects, as well as the first approximation of the structures of their etymologies. And those words that denote entity-objects and relationship cases not yet known in the dictionary are separated for further automated analysis. And, if unknown entity-objects and relationships are not detected in the initial stream, the automated logical analysis is complete.

All further steps of the method in this application use different criteria to trace the etymology of entity-objects unknown to the dictionary, and give user some specific recommendations regarding logical errors and inconsistencies found in the initial stream, as well as incorrect usage of nouns and verbs, which could mean even illogicalities in certain areas of the abstract domains' performance. Therefore, when detecting such inconsistencies the user is provided with appropriate conclusions.

On the next stage, an automated logical analysis is performed for those entity-objects and relations, which turned out to be unknown to the dictionary of possible etymologies. And, first of all, the unknown potential composite entity-objects are separated through the automated logical comparison of each of the unknown entity-objects with those that are formed of repeating nouns and verbs from the initial streams by combining them into one composite, i.e. multilateral posts-relational entity-object. Such combining is possible, given their relationship class coincides, in other words verbs coincide between different pairs, since it is due to multiple occurrence of the above mentioned nouns in several different relations from one class. The probability that these objects belong to the composite entity-objects group significantly increases for several similar verbs. If it turns out that this approximation is wrong, it will not introduce any significant incorrectness. It will be refined at the next steps. The presence of logical contradictions and artifacts in the pre-separated groups of undefined entity-objects is ignored at this step.

At the next stage, the automated logical analysis of the initial stream is completed. The last logical comparison is the analysis of the group of those entity-objects and relations that were unknown in the dictionary of possible etymologies and remained after the removal of potentially composite entity-objects. The unidentified atomic entity-objects are separated from entity-objects that remained by using a single logical criterion that, in general, is used to identify any specific value of a natural (not artificially assigned) attribute of atomic entity-object and needs only the entity-object name and its attribute name. This is impossible in case of a weak entity-object, because the weakness is all about the impossibility to identify a value of any natural attribute of a weak entity-object without knowing its relationship to a functionally dependent, i.e. hierarchically higher entity-object. At the final step of the automated logical analysis each entity-object, which remained from the previous steps receives the status of either atomic, or a weak or an uncertain entity-object. And the presence of artifacts is ignored at this step. And they also get one of the above-mentioned statuses.

If, after the automated logical analysis of the initial stream of entity-objects and relationships the group of undefined entity-objects having controversial semantics doesn't become empty (that is, those objects cannot be put to any of the above-mentioned categories using the automated logical analysis), then each of those controversial entity-objects is forcibly given the status of an atomic one. But it fact is necessarily marked at the level of their cell identifier by adding a specialized separate member to the unary identifier. Thus a separate subgroup of controversial entity-objects is formed in the atomic entity-objects group. During the usage of the warehouse and when a modification to its scheme is needed, this subgroup allows a user to introduce some necessary respective corrections.

The method needs some additional information to carry out any further steps, if this information was not introduced from the initial streams, concerning no less than two natural attributes of each entity-object being analyzed, as well as a few (as the common practice has it—not more than three) values of each of those attributes.

During the next step, the artifacts (i.e. duplicate entities) are finally separated from the preliminarily selected entity-objects' groups. To do this, an automated statistical comparison is performed. It is based on common procedures of statistical analysis for identification of determined functional or correlation or regressive polysemantic dependencies between data values in the entity-objects attributes. Presence or absence of such dependencies enables one to confirm or disprove the direct coincidences of attributes groups, as well as any disguised etymology and a semantic structure obtained at the previous steps.

As some research prove, in order to track down the presence of direct coincidences of attributes copies it is sufficient to compare no more than ten groups of values i.e. no more than ten groups of corteges for the relational warehouse format of entity-objects attribute values. To track down the regularity at this step no more than two natural attributes are sufficient from each entity-object. To track down for example the multivalued dependence observable only between attributes of composite entity-objects and separately between attributes of each of their ancestors which were involved in formation relationships of those post-relational composite entity-objects, it is enough to compare no more than two hundred groups of values. That is not more than two hundred groups of corteges for the relational warehouse format of the entity-objects' attributes values. Between each cumulative value of samples of overall set of all individual attributes of ancestors and values of samples of any or even each of the attributes of the composite entity-objects there emerge not even multivalued but determined functional relation, provided that those ancestors formed this very composite entity-object. The presence of this determined relationship is a sufficient condition for identification and separation of composite entity-objects. Moreover, to track down this regularity no more than two natural attributes are sufficient from every entity-object.

Nevertheless, all the entire set of values of all attributes from all entity-object of the abstract domains should correspond to a single time point in the abstract domains' life for the statistical analysis to be correct. The distance between adjacent temporal intervals should be sufficient for the emergence of a truly new state of the subject filed. After all, if this condition is not met, the regularities may be incorrect.

If there are direct coincidences of attributes' names as well as coincidences of their values in various entity-objects at that step, then the method will separate the artifacts. It will also state this fact at the level of their cell identifiers. This will allow the user to figure out the issue of extra data warehouse. Nonetheless, the situation when the attributes' names belonging to different entity-objects are different but their values are identical due to some of reasons, is clarified with increased number of attributes. If the number of the attributes values is no less than one hundred then the coincidence is not incidental. This is reflected in the cell identifier structure.

The next step features the construction of a refined approximation of the separation. It is necessary, for this purpose, to separate the time-dependant groups of attribute values from non-time-dependant groups of attribute values. Or dependant on very considerable time intervals—their development and changes may be neglected in comparison with other groups of attribute values. Moreover, the almost-time-independent group of attributes refers to a group of entity-objects that create abstract domains' structure. The structure of any system is much slower time-dependent than its very function, i.e. the formation of certain relationships between entity-objects. Thus, a group of time-dependent entity-objects is used for the next refined approximation of composite entity-objects at this stage.

And the other group receives the status of a set of atomic, atomic-indefinite and weak objects. Artifacts were disposed of from the initial stream at the previous steps. And this is reflected in the corresponding cell identifiers. After that each composite entity-object from the newly obtained group is compared with a group of composite entity-objects, which remains after the automated logical analysis. And, if there are coincidences, the cell identifiers remain unaltered. In another case, there emerge a few relevant independent cell identifiers in each of the potentially composite entity-objects (that is, a few potential etymologies to register that circumstance). And these entity-objects obtain the status of indefinite, nevertheless, potentially composite ones, with their etymology to be verified further on.

At the next step the group where atomic and weak entity-objects are selected, the atomic entity-objects are repeatedly and more evidently separated from the weak ones based on two criteria, which are simultaneously used. The first criterion is that it is sufficient to have a name of an entity-object and a name of an attribute to identify any of the value of a natural attribute of an atomic entity-object. This would be impossible in the case of a weak entity-object. But such a comparison at this step is carried out on a much larger quantity of data. The second criterion of the method has purely mathematical origin and is all about a functional dependence among the attributes of the descendent and the collective attributes of all ancestors. Therefore this functional dependence is a determined relationship, which makes it possible to track not only the fact of weakness, but also to specify the members of relationships with older entity-objects. Moreover, if the relationship from a descendant to an ancestor is established unambiguously, checking the presence or absence of unambiguous feedback from the ancestor to the set of its descendants is only possible thanks to interpolation of the attributes of all the descendants of the next level. That is, thanks to the transformations of the set of these values into a mathematical function and inspection of deterministic dependence at a segment in the vicinity of a particular attribute of a descendant. And thanks to tracing a determined relationship, i.e. in a periodic function. And the interpolation scheme itself is widely known algorithms selected on the basis of the abstract domains' specifics. In most cases it is sufficient to use a certain type of polynomial interpolation, where the arguments of polynomials can be either explicit form of attribute values, or Boolean variables. The confirmed relationship is reflected in the structure of the entity-object cell identifier.

However, if at this stage it appears that some of the entity-objects are incorrectly categorized as being weak, the more refined etymology of each potentially weak entity-object will be defined at the next step. This error can occur only due to the fact that etymologies of weak and composite entity-objects are similar. The “slow” dependence of a composite entity-object on the time may result in the erroneous separation of such an entity-object. A possibility of an atomic entity-object dependent on the time being mistakenly classified into the group of composite entity-objects is practically excluded. Therefore, this situation is also clearly defined at the next step.

The framework of the complete set of data relationships is constructed in memory as a pattern, based on the set of atomic and weak entity-objects obtained at the previous steps of the method; it is used to further clarify not only the nature and belonging to a group of composite entities, but also to finally restore the exact structure and origin of each member in the etymology of each composite entity-object, when the use of comparison techniques described above is not sufficient. Further iterations of the procedure of successive approximations of comparison of the potential composite entity-objects with patterns are carried out within that synthesized complete set as follows:

1. A basic set of entity-objects is formed on the basis of atomic and weak entity-objects groups: a subgroup of virtually atomic entity-objects is joined with the selected group of atomic entity-objects. This subgroup is obtained by adding a separate unary identifier to the identifiers of weak entity-objects, as if those entity-objects were atomic ones, thus creating, the initial set of simple unary identifiers. This action is purely technological in nature and facilitates further steps to establish combinations of cell identifiers: the designated virtual atomic entity-objects, which originate from the weak ones, comprise both etymologies—is the natural, composite one and the artificial, unary one. But this leads to no contradictions in either the data manipulation, or tracking data integrity, or with further modifications, since each virtual entity-object retains the determined binary relationship between the natural composite cell identifier and the artificial unary one. The same relationship is seen in all subsequent composite entity-objects, which are synthesized during the further steps of the method. This is a fundamental difference between such procedure in the method in this application and the procedure of automatic assigning of a unary identifier to any object without taking into account the semantics which is typical, for example, for an object-oriented model.

2. A single domain of memory is allotted for each unary identifier of each entity-object from the basic set in the warehouse to place warehouse identifier elements, whose structure is strictly unary. Thus, the initial set of simple single domains is created in the memory. In this case, the identifiers of the weak entity-objects may be designated later. Nevertheless, the way to install these labels can be arbitrary up to their absence.

3. A framework template of standard composite entity-objects is synthesized in the warehouse. For this purpose a combination of Cartesian multiplications of the above-mentioned single identifiers to each other on the principle “each for each”. This procedure generates a system of domains with multi-ary identifiers. The structure of some of them strictly corresponds the structure of the functional part of the corresponding synthesized composite predicates. The structure of some of them corresponds to the structure of the composite entity-objects from the third group of the method. By doing this a complete set of composite domain is obtained, which means that every K-ary composite domain in this synthesized set is generated by Cartesian product of K-samples of the atomic (or virtually atomic, i.e. weak entity-objects—at this stage it does not matter) entity-objects, i.e. K-th sample from the basic set. This synthesizes the full framework of named structured cells for distribution of data from the attributes of the composite entity-objects from the initial stream. That is why such a framework can be used as a template. The total number of such composite domains with identified cells equals the number of sets of a power set, i.e. the number of combinations of sets of all subsets. A number of tables with data (the data obtained in the future in warehouse thanks only to the semantically joint composite entity-objects) will be identified by the specificity of particular abstract domains. But as a rule, they are much smaller in number. At this step, the values of all attributes received from the initial stream of the attributes object's abstract domains description are placed into the cells of the synthesized framework template. This is effectuated considering the etymologies found, i.e. the cell identifiers.

4. A final verification of how the groups of attributes of atomic, composite and weak entity-objects from the initial stream and formed atomic and composite identifiers match each other is carried out by means of the statistic analysis procedures using some concrete data values. And the method offers the multiple compliance clarification possibility through the use of a repeated procedure of successive approximations and the basic set multiple modifications, that is, of an appropriate framework template. Ultimately this will lead to a complete coincidence of the etymology of all the entity-objects from the initial stream with the etymology of the artificially on the framework-synthesized ones.

The method provides the option of the logical and statistical analysis procedures developing. To do this individually an external library is individually built. It is replenished with new subordinate ways of both logical and statistical analysis with its new criteria, which are developed by users. Therefore, a list of subordinate methods of comparing data among themselves, as well as a list of criteria for comparison is not restricted. The sequence of the mentioned procedures performances is not restricted either. Obviously, the most accurate separation can be done either through a dictionary of possible etymologies, or through automated statistical analysis on a framework template. The former type of separation is also the fastest; the latter one is the most long-lasting. Therefore, in the absence of the entity-objects in the dictionary, the performance of all other, i.e., the intermediate iterations, greatly accelerates the framework separation. It allows you to fully analyze the data. If the dictionary of possible etymologies at the initial stages of its existence is not complete, continuous operation replenishing it, ultimately minimizes the need in an initial stream automated logical and statistical analysis.

In the framework model theory the theorems of completeness and uniqueness of the framework, built on the power set of the basic set of entity-objects are proved, as well as the theorems of its consistent growth. The main consequence of these theorems is the conclusion that the composite entity-objects do not form any further relationships among themselves and do not generate subsequent entity-objects. It is not difficult to prove that if any composite entity-objects set is artificially assigned the status of the atomic with artificial unary identifiers and multiply them again, then the formed new (artificial) composite entity-objects (in fact—relationships of relationships) can be obtained on the “previous” framework, provided that under the new multiplication of duplicated identifiers are excluded from the tables. It corresponds to the relational model and the common sense. This means that the basic set of entity-objects is also a basic set of identifiers even without renaming the identifiers. With this restriction synthesized composite entity-objects do not extend the basic set. Nevertheless, any extending the basic set of entity-objects gives rise to new composite entity-objects. Therefore, if there is still such a need, the method enables the artificial modeling of some further relationships through the extension of the identifiers basic set, for example, by adding the artificial atomic entity-objects (obtained from the composite ones by means of installing artificial unary identifiers in their structure) to the initial set. Such a situation can arise, provided that for some abstract domains it is characteristic of to expand their structure at the expense of the synthesized composite entities. In this situation it is important to mandatory add multiple identifiers, responsible for the different states of composite entity-objects or their masks. The record of numbers of intervals of time of such modifications in these identifiers is no less important. It is subject to discussion later on. It is this mechanism that enables to make changes in the scheme of such a warehouse according to fully modified principle and not with significant alterations as the repository of both the scheme itself and its exploitation system.

The first stage of the method in this proposal can be used as a self-contained method, because it provides a universal technique of data separation, an algorithm independent of the peculiarities of arbitrary abstract domains—this technology allows performing an automated analysis and decomposition of arbitrary abstract domains.

The remainder of the algorithm is aimed at forming the warehouse and fully modifiable location data in it. At this step there begins the second stage of the method. To construct the modified method of placing data in the warehouse the framework is also used. First of all, all the possible partial copies of the entity-objects are taken into account, forming masks of entity-objects. Only after that all the relationships between groups of entity-objects are modeled in the abstract domains. Here, the mask denotes such an entity-object partial copy (such an artifact), which is the carrier of a limited group of attributes of this entity-object that are only responsible for one specific role of an entity-object. Each entity-object can have a number of different masks in abstract domains—either many, or few, or only one. Nevertheless, as is pointed out below, the number of masks is due to the number of roles of the entity-object in the abstract domains, i.e. relationships in which the entity-object participates. For example, if a “person” entity-object is under consideration then there can be a significant number of such masks. These are “specialty”, and “position”, and “rank” and “academic degree”, etc. Nevertheless, if this is an “animal” entity-object, there can be a lot less masks: “pets”, “wild animals”, “cattle”, etc.

The prototype method also takes into account all the possible connections between groups of entity-objects that can be formed in some abstract domains. However, it does not account for the influence of the diversity of roles of each entity-object (the entity-object masks) on the variety of connections, which limits its application and does not allow the flexibility to take into account the role of entity-objects in some abstract domains.

Thus, at the second stage of the method in this application, the forming of the warehouse is carried out as follows.

1. Each entity-object is allocated a few sites for placing the warehouse elements in the memory, i.e. they place the domain-mask with the cell identifier in each memory section. The structure of the latter strictly corresponds to the structure found in the previous etymology stage. Thus, a lot of domain-masks are created. The term “mask” is used in the meaning of an entity-object's logical partial copy. The “domain-mask” is used in the meaning of the physical location of data from the mask at a memory sight. Domain-masks are assigned to all the masks of the basic set of entity-objects—that is to say, to the masks of the weak entity-objects. Since, in general, the weak entity-objects depend upon the entity-objects chain (where each entity-member, in its turn, is also a weak entity-object, except the highest entity-object in this chain) masks are assigned as if this relationship does not exist. I.e., it is similar to the procedure for obtaining a basic set of entity-objects, ignoring the hierarchical dependence. And in this case such an ignoring the hierarchical dependencies between entity-objects is temporary. The algorithm of the method provides a further accounting of all types of relationships between the mask and, hence, the hierarchical relationships between entities. Therefore, this action will not lead to the loss of hierarchical relationships. It is assumed that one mask uniquely corresponds to one role, and vice versa—performing one role, i.e. participation in one relationship type requires from the entity-object the using of essentially the same mask. A method user (a warehouse designer) should only keep track of the semantic matching of each mask each role, i.e. correspondence between masks and relationships.

2. The formation of the extended framework of masks relationships is carried out—the combination of Cartesian multiplications of all the mentioned domain-masks among themselves according to the principle “each with each”. The total number S(t) of thus obtained tables for the relational warehouse model increases substantially in comparison with other methods. Given the quantity of masks of each entity-object and depending of the quantity of entity-objects on the number of time period of the relevance of warehouse structure, the total quantity of tables is defined by:

$$S ( t ) = {\sum }_{K = 1}^{NN ( t )} \frac{NN ( t ) !}{K ! ( NN ( t ) - K ) !} = {2}^{NN ( t )} - 1$$

where K is the current arity of the domain-masks relations groups, and NN(t)—the total number of domain-masks, which depends on t—the number of the time period of the relevance of warehouse structures, during which this structure does not undergo any modification. The total number of domain-masks is defined by the formula:

$$NN ( t ) = {\sum }_{i = 1}^{N ( t )} {\sum }_{j = 1}^{M ( i , t )} α ( i , j , t ) ,$$

where, in its turn, a(i, j, t) are the marks of the domain-mask relevance, a formal array of integers, each of which is determined by a set of indices (i, j, t) and within the method in this application is either assumed to be zero, representing the annulation of the domain-mask, or 1, which represents the relevance of domain-mask; i is an index that represents the entity-object's number; N(t) is the total number of entity-objects in the time interval t; M(i, t) is the quantity of domain-masks of each i-th entity-object in the time interval t, and j is the index that represents the quantity of domain-masks of i-th entity-object, the total amount of which for a single entity-object is formed by the inner sum. Thus, the external sum forms the total number of domain-masks.

Apart from this it should be noted that the quantity of domain-masks of any entity-object cannot be arbitrary or separated from or any quantity of other domain-masks of this entity-object or other entities. The appropriate mask should be presented on the part of each participating entity-object in course of the binary, ternary or higher arity relations. This means, in its turn, that the masks are actualized or annulled synchronously with actualization or annulation of the respective relationships, i.e., the roles in which any group of entity-objects are involved. This correspondence of masks greatly simplifies the construction of conceptual abstract domains model. Using the above mentioned correspondence from the group of artifacts obtained at the first stage of the method, the “concealed” masks are selected. Their presence is not obvious at the beginning of the automated logical and statistical analysis of the abstract domains.

3. After that, the semantically obtained compatible relational tables are filled out with relevant data (the entity-objects attribute values) in the synchronized way.

The feature referring of the attributes-characteristics to a mask is a semantic one, that is, a predicate dependence on the specific characteristics-attribute on the specific entity-object's mask object. The procedure for such classification agrees with the framework model. The account is taken of: 1) the fact that each attribute belongs to only one unique entity-object 2) the fact that only the set of all the attributes constitutes a complete set of mutually-independent set of properties 3) the fact that unification of various groups of characteristics from various predicates (i.e., from various entity-objects) into one entity-object (one set) (which is often observed in the artificial entity-objects (artifacts)), or into a relational table, often leads to the appearance of unwanted inter-attribute functional dependencies.

The formal characteristic of a correct selection of the entity-object attributes into a separate mask is the absence of transitive dependencies in the set of such attributes, as well as the absence of some composite potential keys in some corteges of relational tables, which are formed on the entity-object mask attribute set while using a warehouse relational model. The only exception is only one composite potential key—in total, all attributes. With this principle of the attribute entity-object attributes selection into the entity-object mask attributes set the latter does not let for the conditions of the composite keys parts functional dependence on the non-key attributes.

In this case any attribute is always functionally dependent on its predicate—a “senior” entity-object. But it cannot be transitively dependent on a partial set of attributes of the same entity-object (even if they belong to its other masks). Therefore, within a group of attributes (all belonging exclusively to a certain predicate, that is, a particular entity-object (and its partial copy—mask-holder) no inter-attribute functional dependencies exist.

Thus, the mask itself is not only a named partial copy of an entity-object, but also the exclusive carrier of a group of mutually interindependent attributes of this particular entity-object. Thus, each table that is created on the basis of domain-mask, contains only structured cell identifier and a group of functionally independent on one another mask attribute, which depend only on the identifier.

Thus, the method provides that while using the relational scheme warehouse each domain-mask is in a normal relational Boyce-Codd form. And since the relational tables displaying the domain-mask cannot contain any multivalued dependencies, the method is to ensure that they meet, at least, the 5th normal form.

It should be noted too that the composite method of forming the structures of relational data tables through a functional dependencies management algorithm was proposed by P. A. Bernstein in 1975 (Bernstein P., Swenson J., Thichritzis D. A Unified Approach to Functional Dependencies and Relations.—Proc. 1975 ACM SIGMOD—International Conference on the Management of Data, 237-245; Bernstein P A Synthesizing third normal form relation from functional dependencies, ACM Transactions on Database Systems 1:4, 1976, pp. 277-298). The same source pointed out that by the functional dependence a relationship between entity-objects and between entity-objects and attributes is implied. Nevertheless, since the input factors of the above-mentioned method are a set of functional dependencies of certain abstract domains, this is its major shortcoming. After all, relational schemes formed in accordance with this algorithm, depend on the abstract domains' semantics. Unlike it, the method in this application provides an algorithm of abstraction from functional dependencies, i.e., from the influence of relationships semantics on the data warehouse structure.

On the one hand, the reservation of certain number of domain-masks of each entity-object is carried out in accordance with the terms of particular abstract domains. I.e., they take into account that the number of groups of independent attributes of a particular entity-object detected in abstract domains, equals the number of domain-mask of this entity-object. Nevertheless, the account is also taken that the number of domain-mask is a conditional parameter. In the method in this application there are no restrictions on the number of entity-objects and the total number of domain-masks. Therefore, on the other hand, the reservation of memory slots for domain-masks allows for the possibility of greatly increasing both the number of domain-masks, and the number of multi-ary tables.

Another difference of the method in this application is in the structure of the cell identifier, which may have a common name for all of tables and cross-indexing, three-dimensional structure indexation (i, j, t). The indices have the same contents as in terms of the total number of domain-masks. Each of the key indexes is uniquely responsible for each mask of each entity-object. That is, each index is responsible for its base factor of the method, namely: i=1, N(t)—represents the number of each entity-object, where N(t) is the total number of entity-objects for the t-th time interval, j=1, M(i, t)—represents the number of masks of i-th entity-object for the t-th time interval, and t is the number of the time interval of the relevance of the current state of the t-th modification of the set of all (i, j)-th relational data tables.

So, for the time interval having the number t, the structure of the entire set of tables with the relational-table warehouse schema remains unchanged, i.e. not modified. And at the moment of time, which has a number of t+1, the same set of tables has already obtained its state modification. Such modification may be either in a minor change of only the size of one of the columns of already existing table, or the addition of a new group of tables. A user of the method gets the opportunity to nominate and use any formal condition for the transition to a new time interval code of the relevance of a current state of warehouse structure, and hence to a new set of tables and corteges.

Thus, the method ensures that any modification or warehouse structures will not affect the relationship between previous data and thus will not lead to radical transformations of the tables. In the framework model theory this assertion is strictly proved as the theorem of a noncontradictory growth of the framework. Due to the same encoding of time intervals during which the state of the structure of the set of tables is still valid, the method provides the opportunity to analyze all the layers of the states of the tables' structure either separately from one another, or as a complete set. Such a technique of warehouse constructing provides the opportunity to store each individual t-layer of the set of tables in its entirety with all the obtained data over this period of time. Besides one gets enabled to build a temporally-layered data archive, which differs substantially from the data cubes' archive.

In this method there are also no restrictions in terms of the moment of adding some additional domain-masks from the initial, or even the new entity-objects not accounted for by a designer at the initial stage. This addition is THE mentioned modification of the warehouse structure's duty state.

The essential innovation of the method is the option for relational warehouse scheme to provide a separate multi-ary relational table to each composite entity-object (in fact—each relationship between entity-objects). This, in its turn, allows the user not to restrict the conceptual design model and not to reduce multi-ary relationships between entity-objects to the binary ones, as recommended by many well-known theories of constructing relational warehouses. It is the multi-arity of relations which is one of the hallmarks of arbitrary abstract domains. The method also allows you to use only those multi-ary tables in the warehouse structure, the former containing the relations attributes apart from the multi-ary keys. As follows from the well-known Fagin's theorem (Fagin, R, Multi-valued dependencies and a new normal form for relational databases, ACM Transactions on Database Systems, vol. 2, no. 3, 1977, p. 262 278), the multi-ary tables, every cortege of which is built only on the Cartesian product of key attributes of several entity-objects (where the number of entity-objects is more than two), have abnormalities of the “multi-valued dependencies” type and do not belong to the 4-th normal form. Nevertheless, if independent attributes (the characteristics of this connection) get added to each relational table the multi-valued dependencies get transformed to the functional ones. The relational table gets rid of these abnormalities. This table belongs to the 5-th normal form. But the set of this table—to the DK/NF.

It is for the sake of the attributes (effectively the relationships) of the composite entity-objects that multi-ary relational tables are created. A variety of types of relationships (which tie entity-objects from the basic set in some abstract domains) is modeled by many multi-domain-masks, because each mask, as mentioned above, is the unique group of entity-object characteristics to perform a particular role, that is, to remain in this relationship. But within the method in the application there is an opportunity not to use multi-ary relational tables without relationship attributes, i.e. with anomalies—not to actualize them. The tables with multivalued dependencies in their structure, which: a) have only some key identifiers in their composition, b) are built on the Cartesian product of keys members, c) and do not have the relationships attributes, model only the probability of a relationship. But they have no actual information—they lack the characteristics of this relationship. In the method's algorithm there may be an option of deactualization of such tables.

An additional “physical” meaning of the constants a(i, j, t) is also the fact of a definite mask multiplication, when a certain constant equals to 2, 3, 4, etc. This, in its turn, implies the modeling of possibility of multiple simultaneous performing of role one by one entity-object. Thus the entity-object participates with its mask in one relationship type several times. This situation has no parallel in abstract domains. Indeed, as already mentioned, the principle of uniqueness is used—each mask is used only for one role, and in each role, i.e. the entity-object participates with the mask only once in each type of relationship. Therefore, even a recursive relationship of arbitrary arity of one and the same entity-object (which in theory in data warehouses design is regarded to be one of the most essential contradictions of the abstract domains), is organically modeled in the method due to various domain-masks owned by one entity-object. Nevertheless, within the method in this application, additional generation of domain-masks (which is purely theoretical situation) will not cause major structural problems and contradictions. The only thing that arises here—is the need to distinguish the key attributes of the same name. Nevertheless, the appearance of additional semantically non-defined domain-masks, as well as relational tables, being generated by them, can significantly affect only the performance speed of procedures for monitoring the integrity of the entire warehouse. This significantly reduces the optimization of its use Annulling or, in other words, actualization the domain-masks for a certain period of actuality time is one of the varieties of warehouse structure modification.

A significant advantage of the method in this application is the ability to use physical data warehouse model in full accordance with the logical model. This means that the method solves the Codd's classic problem about finding the optimal solution between a universal relation (extreme unification) and large collection of binary relations (extreme decomposition). Historically it is believed that neither option has future. But these contradictions more affect modeling of the physical location of data in a digital warehouse. The method is a formalized Codd's solution. When it is asserted that for some abstract domains there is a universal equivalent, logical and physical free-of-anomalities model of data distribution, thus it is asserted that the Codd's problem has been solved.

Thus, the unique construction of the structured cell identifier allows the user to design a physically-distributed data storage system, taking into account the positive features of the relational model. Each value has a unique identifier and can be located directly into the digital memory. And this identifier, on the one hand, is a relational key, and the carrier of the basic properties of the logical data model. On the other hand, it is a factor of addressing the data in the warehouse. When building a distributed warehouse the key factor for allocating one or another group of data to the different servers on the network is the statistics of queries. The aforementioned warehouse structure provides an opportunity of separately storing data groups without loss of their relationships. This concept of a storage creation greatly increases the flexibility of the warehouse structures.

Thus, the sequence of the method's second stage runs as follows:

1. Abstract domains are restricted: groups of entity-objects are selected which have been selected into different groups after preliminary separation.

2. The procedure of reserving of domain-masks is carried out as many times as is set by the requirements of each entity-object from the basic set of procedures. It is recognized that the number of that domain-masks quantity of each entity-object is a conditional parameter. Both equivalent and weak entity-objects are modeled as equivalent masks. I.e. between sets A and B of the entity-objects there generally emerge “many-to-many” relationships. Each entity-object from the set A may independently enter into a relationship with any subset of the entity-objects from the set B, as well as in relation to any subsets of the entity-objects from other sets, i.e. C, D, . . . , N, . . . , Z, etc.

3. For each domain-mask of each entity-object, a key attribute is assigned—a structured cell identifier, which strictly corresponds to its etymology, and is obtained at the first stage of the method. The identifier may have a common name.

4. Another dimension is added to the structure of the identifier according to the principle of an indexed three-dimensional array. For example, the identifier of the first mask of the first entity-object for the first interval of actuality time may be indicated, for example, as K(1, 1, 1) or K₁₁₁. It may also denote the address of a digital memory cell: K010101 or K001001001 etc. depending on the design range of the number of corteges in the tables, for which the key is being designed. Thus, a separate directory is formed stating which entity-objects belong to which groups—after building a warehouse the user should be able to distinguish entity-objects from one another.

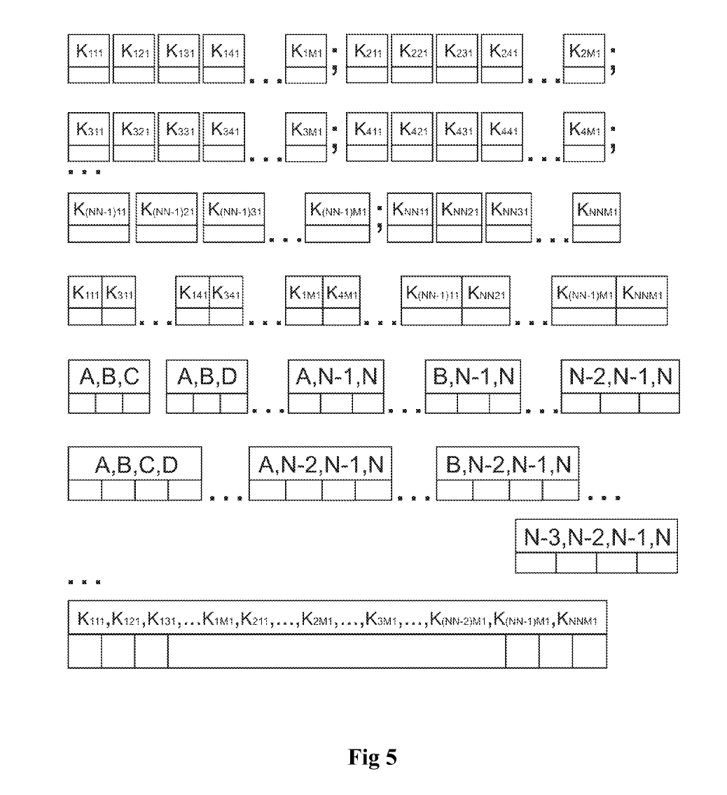

5. Within the set of obtained domain-masks by means of Cartesian multiplication of identifiers of domain-masks onto one another they create an extended framework for future relational tables of relationships (FIG. 5), which does define the structure of the warehouse. Moreover, multiplication is carried out according to the principle “each onto each”. So, at the primary level, we have NN(t₀) domain-masks:

$$NN ( {t}_{0} ) = {\sum }_{i = 1}^{{N}_{0}} {\sum }_{j = 1}^{M ( i , {t}_{0} )} α ( i , j , {t}_{0} ) ,$$

where a(i, j, t₀)=1 for all (i, j, t₀); t₀ is the number of the initial period of time (which may be 1); i is an index that represents the number of entities, N₀ is the quantity of entity-objects of the initial period of time t₀; M(i, t₀) is the quantity of domain-masks of each i-th entity-object of the initial time interval t₀, and j is the index that represents the number of the particular mask, the total amount of which is provided by the inner sum. And the outer sum gives the total number of domain-masks.

This initial time period at the levels of arity higher than one, will comprise NN!/(2!*(NN−2)!) of two-column, NN!/(3!*(NN−C)!) of three-column, NN!/(4!*(NN−4)!) of four-column, and so on . . . , NN!/(NN−1)! of (NN−1)-column and 1 of NN-column relational tables, where NN is the sum of all the masks of all entity-objects. For the sake of simplicity, the constant NN is denoted here without reference to the number of the time interval t₀.

6. For each key table obtained, an identification key is generated by multiplying identifiers that were contained in the set of domain-masks. They are located in the respective tables similar to the domain-masks. That is, each group of the generated identification keys is located in the table, which is a direct product of groups of domain-masks corresponding to those keys.

7. A system of group navigational functions is constructed, by means of which the semantically related data tables formed in-warehouse are simultaneously filled in quasi-real time with the respective data. And these data groups are processed. Thus, the group monitoring of their integrity, group introduction, group correction, elimination of the group, group viewing, the output data, etc. are maintained here. At the same time, only those semantically compatible tables are filled with data that are in line with the expected semantic queries from users. The greater part remains in “reserve”. They are updated only in accordance with the emergence of unexpected requests. Thus, semantically incompatible tables may be irrelevant and kept empty according to the principle of “just in case.”

To construct a data warehouse that would have a high response speed with both relational and object-oriented queries, each atomic attribute of each entity-object, i.e. each atomic data set, which is combined with unary part of the generally multiplace predicate into an attribute of the entity-object and is given its own unique structured identifier. The overall part of the structure of this identifier is constructed in accordance with the structure of the etymology of the entity-object, i.e. the structure of the functional part of a multiplace predicate. And the last, unique member of the identifier corresponds to the values of the atomic attribute. This addition allows you to perform queries using the indexing of the identifier in accordance with its structure, which greatly increases the response speed. And it makes it possible, in its turn, to combine the properties of the table and non-table warehouse forms. This non-typical form is obtained by means of non-table unification of data sets into data into attributes of the entity-objects in accordance with those related by names and identifiers' structure. This new property is also important for the evolution of the data scheme for the storage operation.

The warehouse, constructed in accordance with the method in this application, has another advantage. Suggested is the opportunity of separate and parallel processing of each datum independently one from another, or batch processing of several combined data groups dependent and independent on one another. And there is no need for strict compliance of each datum of the common attribute one to another in value, type or size (while it is required, for example, by the relational method of distribution, since each datum is required only to have a common identifier with the structure corresponding to the structure of the overall predicate.

Thus, the method claimed creates the universal technology of data distribution in a digital warehouse, which does not depend on the characteristics of particular abstract domains and allows to perform any modification of the warehouse scheme and data structures dynamically and without alteration of the exploiting system by means of minimally sufficient operations and perform any semantically reasonable modifications of the warehouse scheme and data structures and form a set of unique data processing procedures—the group functions. And thus to standardize the technology of generation and operating the data warehouses.

The essence of the invention is illustrated by drawings.

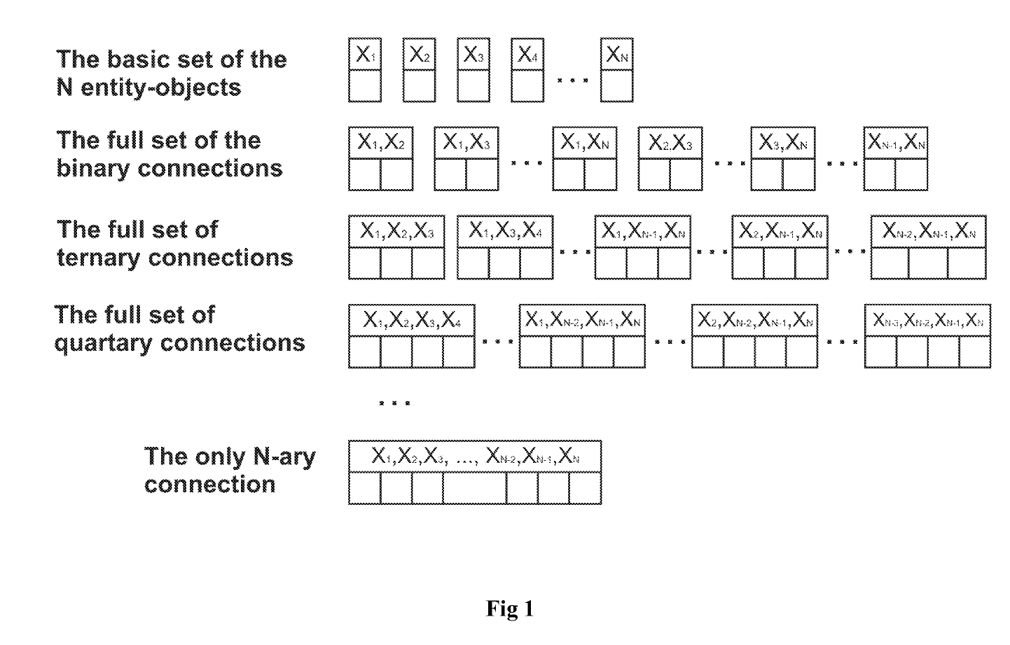

FIG. 1 shows the general structure of the framework template, built on power set of the basic set of N entity-objects.

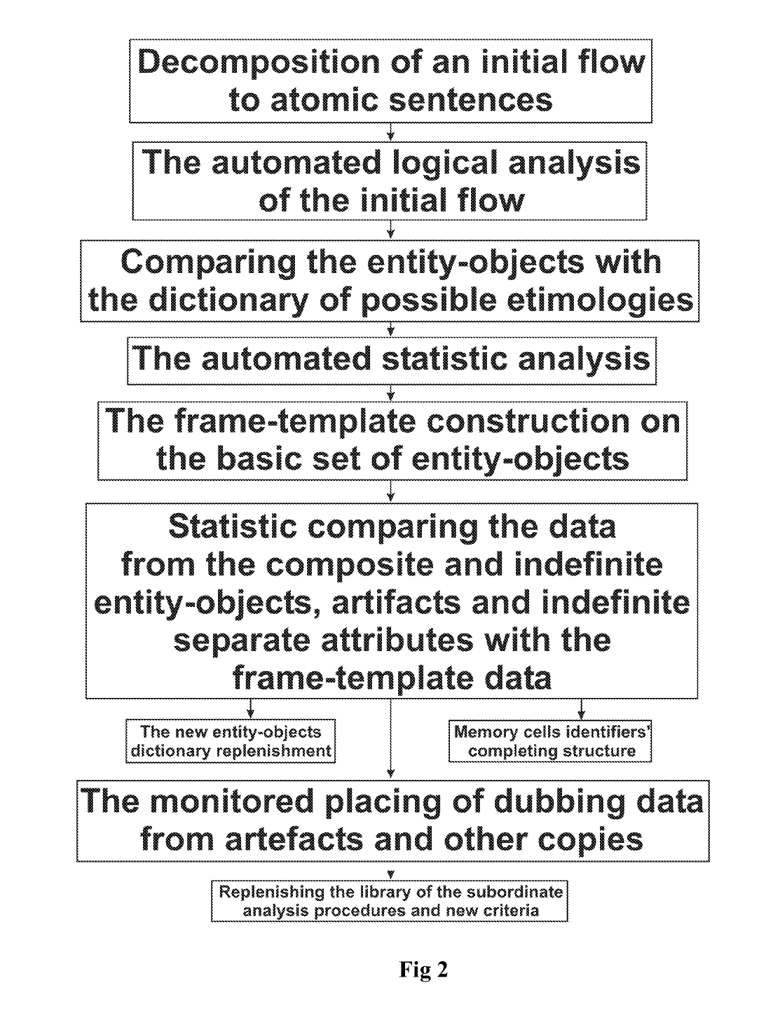

A generalized sequence of steps of the method's first stage is shown in the block diagram in FIG. 2. The essence of the important properties of the method in accordance with the item No 19 of the “invention formula” is shown in the drawing, where

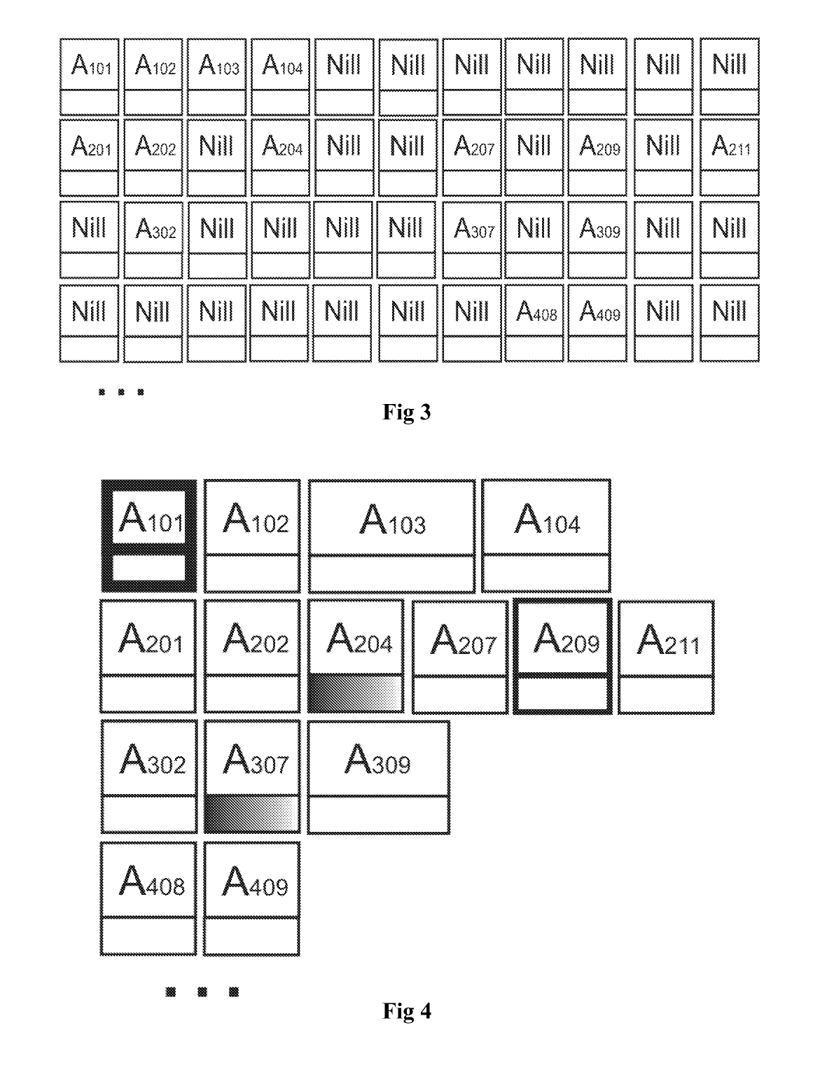

FIG. 3 shows a partially completed table with randomly placed data. Here the term “nil” denotes the lack of data. A filled cell is indicated with the letter A (as in “attribute”) and an index, where the first single-digit figure refers to the row number of and the second double-digit—the column number. Thus, the FIG. 3 shows the canonical form of a table, in which, in spite of the empty cells, all the columns and rows can be traced.

FIG. 4 shows an optimized form, where there are no empty cells. It also shows the attributes similar in structure of the predicate that should not necessarily have the same dimensions. This provides an opportunity to combine the properties of relational and object-oriented methods of distribution.

FIG. 5 shows a diagram of the extended framework, built on the power set NN(t) of entity-objects' masks—a universal warehouse structure, which models arbitrary abstract domains, where the K₁₁₁,K₁₂₁,K₁₃₁,K₁₄₁, . . . , K_{NNM1} is a set of structured identifiers of endless columns of domain-masks, as well as the structure of multi-ary tables for each level of relationship, obtained by the Cartesian multiplying of domain-masks onto each other. In this case, the letter M denotes, as above in the text, the array dependent on the number of entity-object. That array denotes the number of masks of each entity-object. To save space in the diagram-drawing, the “i” symbol is not given. For the same reason, some random tables of binary relationships are indicated, as well as on the third and fourth level of table arity, the generalized sets A, B, C, D, . . . N are shown instead of the three-dimensional identifier Kᵢⱼₜ. Those sets use the symbolic the names of the entity-objects that summarize the names of their masks. The last NN-ary table is shown with the open structure of its key.

In the application materials, the following terms and concepts (not ordered alphabetically, but according to the logic used) are made use of:
Modifiability of a warehouse—the possibility of modifying of the scheme of data storing together with data structures without changes in exploiting system, while in static mode, i.e. after the shutdown of the operating system;
Full modifiability—the possibility of modifying the warehouse schema together with data structures without changes in exploiting system with the minimally sufficient operations, in dynamic mode, i.e. without shutting down the operating system;
A predicate (one of the possible values, used in this method) is a common logical feature of all the elements of the set, especially the set of attributes that provides the option to distinguish between attributes and to determine what entity-object this attribute belongs to. The method is based on a data framework model, where each attribute can have only one unique predicate associating it only with one entity-object. In the general sense the predicate is a function that has only two logical values—true or false (“yes-no”, “your own—someone else's”, etc.). In this model, the predicate can be an integral function, which has a multi-functional argument and composite functional parts. The composition of the predicate is a conjunction (the logical product) of multi-functional predicates, the simultaneous fulfillment of the conditions of each of which returns the general “true” and the failure in the conditions of at least one of them will return “false”. The predicate of the entity-object is essentially a consequence and the carrier of its origin. We consider only two ways of creating of any entity-object—either by generating the weak entity-objects with the atomic ones according to the principle of “one generates many”, or because of peer relationships between the atomic or weak entity-objects, according to the principle of “many generate many”. The simple or compound functional part of the predicate is a consequence of the etymology of the contents of entity-object.
An entity-object is the symbol of a certain atomic contents that is encoded by a word, i.e. in fact, this IS the predicate that combines a set of attributes into one group—the properties of the entity-object. In this model, each entity-object can have only unique natural predicate, and several artificial ones;
Arbitrary abstract domains (abstract domains of any size and any structure) is an arbitrary set of entity-objects, the totality of which is perceived by a user as a unified system, the functioning of which is studied and modeled by the user;
An attribute is a property or characteristics of an entity-object having the same predicate as all the attributes of the entity-object. From this follows an important feature of an attribute—the difference of an attribute from an entity-object (even if there is a coincidence of a noun name, denoting them) is the presence or absence of a “slave” property or characteristics which, in case of an attribute, has no “slave” properties and characteristics;
A natural attribute is a property (or feature), which is not provided by the user of abstract domains, and found among the set of attributes of an entity-object through the analysis of abstract domains;
An artificial attribute is an attribute that is artificially introduced by the user of abstract domains to an entity-object;
Etymology is the origin of an entity-object's contents that appears in the structure of the forming predicate's functional part, and is expressed with the corresponding aggregate string of characters. This string forms the identifier. And, despite the fact that grammars of some languages feature no plural for the noun “etymology”, an entity-object can have multiple etymologies in logical and mathematical sense. Therefore the term is also used in the plural form in this application;
An atomic entity-object is an entity-object, which has a unary etymology, i.e. such that is formed by a predicate having only a unary functional part;
A weak entity-object is an entity-object, which has a composite etymology, i.e. such that is formed by a predicate with only a multi-ary functional part, except for the unary one. It also has the functional (i.e. hierarchical) dependence of each next level of the functional part of the predicate (except the highest one), on the set of the previous ones, i.e. on the set of ancestor predicates;
A basic set of entity-objects is a collection of atomic and weak entity-objects, which does not have there are no empty places among the members of the weak entity-objects. Initial atomic ancestors are defined for each member of the weak entity-objects;
A composite entity-object is an entity-object, which has been formed by a relationship of a certain group of entity-objects from the basic set. It has a composite etymology, is formed with a predicate, which has only a multi-ary functional part, except for the unary one. This predicate has no functional, i.e. hierarchical, dependencies of any member of the functional part on one another. Nevertheless, there is a functional dependence of the total collection of member of the functional part on the total collection of member of the generating predicates' functional parts;
An artifact is an entity-copy whose attributes are the copies of the attributes of other entity-objects, and the combination of these attributes into this entity-object is an artificial one—additional predicates are artificially assigned to each of these attributes and these predicates combine these attributes into this artificial entity-object;
The role of an entity-object is essentially a function of an entity-object in a relationship. In this case, it is provided that each entity-object from the basic set can participate in any arbitrary number of relationships, which is to perform an arbitrary number of roles. For each entity-object this figure is the arbitrarity factor of the abstract domains. The composite entity-objects do not form any further relationships and do not have roles. However, as an exception, if required by abstract domains, certain composite entity-objects can be artificially assigned the status of atomic ones in order to perform certain roles. And they can replenish the basic set;
A mask of an entity-object is a partial copy of an entity-object (an artifact), which is the carrier of a limited group of attributes of one entity-object. This attributes are responsible for only one specific role of this entity-object;
undefined entity-object is an entity-object, the etymology of which is subject to further refinement through some additional information from the abstract domains. Those entity-objects that have no single sample are selected into this group too. They have an abstract name or concept within certain abstract domains and therefore can not be used on their own;
Undefined individual attributes—single attributes that are mistakenly masked as entity-objects due to the same spelling of nouns in the initial stream;
structurized cell identifier is an identifier of the memory cell, which contains data from one or another attribute of an entity-object that has a certain typed structure. In the method the structure strictly corresponds to the structure of the entity-object's etymology and thus, to the attribute's etymology. Therefore, is designated not by a user but automatically, with a separate procedure during separation—it is this identifier which is the result of the desired separation;
string concatenation (string sum) is obtaining a new identifier from some identifier-parts thanks to their linear association on the principle of words creation thanks to the sum of the string letters. And, in some cases, the location of letters in the identifier does not matter, as, for example, in the identifier of composite entity-objects' attributes. And in cases of weak entity-objects the location of the identifier denotes the direction of dependence. As a rule, the direction is encoded from left to right, i.e. left-most side represents the initial atomic entity-object. For example, the string sum of the letters “m”, “e”, “t”, “h”, “o” and “d” will return an entity-object “method” if it is a weak entity-object. Although in reality the entity-objects like “way”, “method” “algorithm” etc. should be classified as “composite entity-objects”;
A word (noun and verb) is a unique set of letters that is simultaneously used as a unique name for the entity-object or relationship in the memory, as well as their name in the speech describing abstract domains which the user is working with. Auxiliary words, without which a sentence cannot have any speech contents, belong to verbs and cause a relationship class;
A sentence (an atomic sentence) is a (binary) relationship between two entity-objects. Complex sentences, i.e. sentences describing several binary or multi-ary relationships, should be decomposed into several atomic ones;
An initial stream of the abstract domains' description is the complete set of atomic sentences describing abstract domains, taking into account all the initial files—audio and textual ones, files of schemes and even the data warehouse files that already exist and are put into operation;
An automated logical analysis is the procedure of logical comparisons of entity-objects' names with a dictionary of possible etymologies, as well as accounting all the relationships between each other i.e. those ones available in the initial stream without the use of the direct attribute values, and without the use of mathematical criteria for the identification of deterministic dependencies of data sets and the mathematical proximity of data between each other;
An automated statistical analysis is the procedure of mathematical comparison of the values of attributes of entity-objects between each other using mathematical criteria to identify the deterministic dependencies among the sets of data on attributes and identifying the mathematical narrowness of relationships of groups of data between each other;
A power set is a term from the formal logics, which means the set of all subsets, i.e. the complete combinatorial combination of sets of any elements.

1. A method for the fully modifiable framework distribution of data in a data warehouse taking account of the preliminary etymological separation of said data, which lies in the fact that the data being placed have a common set of characteristics that meet the general predicate, and groups of entity-objects are to each other in various relationships, and for the input analysis of the data ontologies are used, i.e. the dictionaries of arbitrary abstract domains, constructed in accordance with various factors which is a special one, by each data being placed in the memory call with a structured identifiers, whose linear-chained structure has the form of X₁+X₂+X₃+ . . . , and each atomic element Xₖ of this chain formalizes the origin of meaning of the placed data and can be independently indexed, at that, the structure of the identifier is not random, but is obtained by the synthesis of the Cartesian framework of structured identifier, henceforth—just a framework, that formalizes the simulated abstract domains, and the framework synthesis can be implemented in accordance with the claimed method either by the user or automatically; at the same time, framework of structured identifiers and logic scheme of the warehouse are built in the digital memory in accordance with combinations of Cartesian products of identifiers' domains of all entity-objects from the simulated domain on the principle of “each on each”, forming herewith the framework of the entity-objects' relationships.

2. The method of claim 1, characterized in that the method of automatic or non-automated framework synthesis of a structured identifier is based on recognition of all possible partial copies of entity-objects from the simulated abstract domains, generating data, placed in the memory, regardless of the entity-object's semantics, representing any entity-object of the atomic one, forming masks of the entity-objects after which the relationships between all these masks' groups of the entity-objects in the abstract domains are modeled; for this purpose several sections of memory are allocated to each group of masks in order to accommodate the warehouse elements, i.e. domain-masks are reserved in the memory with the corresponding unary cell identifier, thus creating an expanded initial set of memory sections, and the number of domain-masks that are placed there is equal to the sum of all the masks of all entity-objects, and further warehouse scheme is built in the digital memory in accordance with combinations of Cartesian products of all domain-masks among themselves on the principle of “each on each”, forming herewith the framework of the domain-masks relationships, while the total number of groups of attributes of the domain-masks to be placed, that is, the copies of the entity-objects, significantly increase, compared to other known methods, and correspond to the set of all subsets of the entity-objects domain-masks' relationships; but then again the semantically incompatible entity-objects obtained with the help of Cartesian products combinations may not be taken into account by the user and placed into the warehouse, and this step in the process of forming the warehouse may be regarded as the zero approximation; and at later stages to account for the semantics of an arbitrary abstract domains the logical and statistical analysis of the descriptions of any abstract domains is carried out, and further successive approximations of the analysis on the obtained framework of the relationships as on a template, which allows automated and more optimal data distribution into the warehouse—to significantly reduce the number of semantically incompatible groups of attributes.

3. The method of claim 2, characterized in that for any semantic analysis of the descriptions of any abstract domains, carried out is the input of several digital initial data streams received by means of: converting the audio voice signal, which describes the abstract domains, dictated with a natural language in real time or recorded in a file, or by means of reading a text file of the abstract domains description, formed with the text in the natural language, or reading the file generated with the language of sequential schemes, or graphs that correspond to the description of an abstract domains, or reading a sequence of data storage files that already exist and put into operation, for any further analysis these digital streams are compared with each other to confirm the coincidences or to identify inconsistencies in some masked senses of arbitrary entity-objects, after which they carry out identification and separation of words in the audio stream through some well-known procedures at the next step, or turning a set of schemes or database file structures of the already running warehouse into a verbal stream, and after that—placing all the obtained words from all the streams into the memory with the help of which the coincidences or inconsistencies are detected; besides, while developing data warehouses the described streams are usually formed by various independent sources, so if the development of a warehouse is at an initial stage, a user is to generate several initial streams by several independent experts in accordance with the method's recommendations.

4. The method of claim 3, characterized in that during the next step every word is analyzed in turn on the principle of successive approximations, the method provides the ability to dynamically take into account additional information about the data from the abstract domains, and the total initial stream, obtained in the previous step, the memory becomes in the stream, which has the following form: technological unit of the initial stream for the automated analysis is one atomic sentence, each set contains only two entity-objects, each of which is encoded by a noun with a unique letter by letter spelling, in such a way that nouns that are repeated mean one and the same entity-object, so the repetition within a single sentence means a trivial pair, i.e., one that carries only a declaration of the existence of this entity-object, without relations with others, and the verb between them that represents a binary relationship between a pair of entity-objects with a unique letter by letter spelling, so that verbs are repeated, mean one and the same class of relationships; and method does not provide an upper limit for the number of sentences, and the lower limit is due to the abstract domains' content, however, assume a preliminary formal analysis of the availability for each entity-object declared by the target of at least one relationship with any other entity-object.

5. The method of claim 4, characterized in that in order to convert a file from the initial stream of the abstract domains' description, formed with the language of sequential schemes or graphs, into a stream of words. Each graph figure of a scheme—for example, a rectangle, is associated with a noun, and the arc of the graph, marked with straight or curved line on the scheme, that line connecting these rectangles, is associated with a verb; the method offers a separate procedure for strict isolation the pairs of entity-objects and their relationships from the structural initial stream, as well as their designation with nouns and verbs, i.e. processing the graph schemes such as ER-schemes under restrictions of uniqueness of the name letter by letter naming the entity-objects, and a similar procedure is used in the conversion of the files put in the operation of the data warehouse into atomic sentences.

6. The method of claim 5, characterized in that a separate section is formed in the memory for pre-separation, which houses structured cell identifiers; the structure of each of them is neither arbitrary, nor specified by the user nor obtained in some other way other than as strictly matching the probable semantic structure of each entity-object's contents, which in its turn is monitored automatically through the criteria of the method, which are built on a single generalized factor—the origin of the contents of this entity-object, i.e. its etymology, and in this method we have used the fact that, firstly, in an abstract domains of arbitrary volume; all entity-objects are categorized in three known ways—the atomic entity-objects, which are also called the fundamental, as well as the weak and the composite, i.e., post-relational entity-objects, and secondly, the synthesis of the entity-objects is carried out as follows: the atomic-based weak ones are generated, i.e. functionally dependent on the fundamental, and this dependence can either only be at the level of identification of weak attributes, or at the level of existence of dependent weak entity-objects; the composite entity-objects are created between them thanks to creation of various relations between them on the base of the total set of the atomic and weak entity-objects group, these entity-objects are sometimes called post-relational or multilateral, the composite entity-objects do not form any further relations, do not generate any new entity-objects, and the already referred process of the formation of both the weak and the composite entity-objects masks the parts of speech—nouns or terms corresponding to them, which actualizes the separation; thus all other factors characterizing the semantics of any entity-object in any arbitrary abstract domains are functionally dependent on the etymology, which, in its turn, is described with the mathematical logics of predicates and as a structured string cell identifier has the following general scheme:
X₁^{m}^{₁}+X₂^{m}^{₂}+X₃^{m}^{₃}+ . . . +Xₖ^{m}^{ₖ},
where each member Xₖ_{ᵢ}^{m}^{ₖ} is the separated identifier of the arbitrary i-th entity-object's origin, kᵢ is the number of the identifier member of i-th entity-object, mₖ is the number of the corresponding generating entity-object from the combined group of atomic and weak entity-objects, and each mₖ can receive a value only from the set {1, 2, . . . , N₀, . . . , N}, where N₀ is the total number of the atomic and weak entity-objects, N is a total number of the atomic and weak entity-objects, i is the number of arbitrary entity-object in an arbitrary abstract domains, and in the case of the full set of relationships i={1, 2, . . . , N₀, . . . , N, (N+1), . . . , (2^{N}−1)}, the plus sign means the string concatenation, thus, the only one member Xⁱ, where m=i, is the etymology for atomic entity-objects, i.e. the atomic entity-object creates itself, while in the method claimed the atomic entity-objects obtain the first numbers in the general set, i.e. for them i=1, N₀; for the weak entity-objects the etymology is the above-mentioned string concatenation of members, where Xₖ_{ᵢ}^{m}^{ₖ}-member strictly corresponds to each kᵢ-number, i.e. the sequence of units strictly corresponds to the sequence of dependencies of each subsequent unit on the previous one; that, in its turn, corresponds to the sequence of formation of each previous weak entity-object up to the higher atomic, the following weak entity-object; for the composite entity-objects the etymology is the above-mentioned string concatenation of members, where the location of each member is not strict, i.e. sequence of members does not matter, nevertheless, the total set of members strictly corresponds to the set of creating entity-objects; thus, in the general, all the structured cell identifier is the total string of letters or numbers for an arbitrary entity-object, each member of which has a minimally adequate line size, which means that such an identifier uniquely identifies all the properties of the specific nature of an entity-object, i.e. its attributes, which in their turn are the arguments of the forming the multi-place predicate of the entity-object; the number of places in the predicate is equal to the number of attributes of the entity-object, thus, since the entity-object of attributes may have any arbitrary number, the forming predicates are multi-place, this does not affects the structure of the functional part of the predicate, and hence the structure of the cell identifier, with each member of the etymology of the entity-object has a sense of connection with generating entity-objects that partook in the origin of a particular entity-object if the latter is either weak or the composite one i.e. post-relational entity-object, so that each member Xₖ_{ᵢ}^{m}^{ₖ} of the cell identifier is constructed in strict accordance with the etymology of the entity-objects' contents from the description of an abstract domains, each entity-object in the abstract domains being able to correspond to the predicate being either atomic, or the unary in its functional but multi-placed in its argument part (and hence to have a unary identifier Xⁱ,) or to the predicate being composite in the functional and multi-place in its argument part, i.e. have a composite identifier ΣXₖ_{ᵢ}^{m}^{ₖ} which is summed over kᵢ, kᵢ=1, Kᵢ, i.e., the identifier has the above-mentioned general structure, and functional component of the predicate being the result of unary predicates conjunction, which corresponds to the string concatenation of the sets of data of the identifiers' members, i.e. the summation of strings and the total number of members Kᵢ represents the arity of the functional part of the forming multi-place predicate, which can generally equal to 2, 3, . . . , 10, etc., and in case of an atomic entity-object it is equal to one.

7. The method of claim 6, characterized in that on the next step the data is subjected to the initial phase of an automated logical analysis, i.e., the initial stream of words is subdivided into the following groups by the preparatory automated procedures:
Atomic entity-objects, having unary etymology, i.e. such as those being formed by the predicates having only unary functional part,
Weak entity-objects, which have a composite etymology, i.e. such ones, that are formed with the predicates having only a multi-ary functional part, except for the unary and moreover functional, i.e. hierarchical dependence of each following member of the functional part of the predicate, except older one, on the set of ancestor predicates.
Composite entity-objects, having a composite etymology, i.e. such as those formed with the predicates that have only a multi-ary functional part, except for unary one,
Artifacts, i.e., entity-copies, the data, from which they copy the data from the attributes of other entity-objects, and therefore they will be conventionally placed in the warehouse until after the respective decision of users,
Unidentified entity-objects or individual attributes, the semantics of which is subject to further refinement thanks to some additional information from the abstract domains, and the single attributes are selected to this same group, these attributes being mistakenly masked as entity-objects in the initial stream due to the same noun spelling; as well as such entity-objects that do not have a single sample, but having an abstract name or notion only within some specific abstract domains, and therefore can not be taken into consideration and are separated;
and further the groups of attributes of entity-objects can be placed in the warehouse identifying cells, for example, their names and groups of other characteristics, which are the arguments of the relevant atomic or composite multi-place predicates and unary warehouse cells identifiers strictly correspond to the atomic entity-objects, and the composite identifiers of cells strictly correspond to the weak and composite entity-objects.

8. The method of claim 7, characterized in that consequential or simultaneous i.e. parallel procedure of comparison with each other entity-object is carried out for each entity-object from every sentence i.e. from every pair of the comparison procedure, this procedure fulfilling some separated subordinated logical ways of separation of every masked etymology of each entity-object, and hence the semantic structure of its contents, the result of which is the desired separation, i.e., each cell, where the data are stored from the attributes of each entity-object from the initial stream, is provided with the relevant structured cells identifiers and regrouping of entity-objects in the warehouse in the above-mentioned separately placed groups. The restored structures and origins of each member in the etymology of the entity-objects at this step is carried out through a logical analysis of nouns and verbs, i.e. the analysis of the prospective contents of the entity-objects and contents of relationships, excluding sets of specific values of the entity-objects' specific attributes, and the analysis is based on a comparison of the contents of the entity-objects to each other on an “each with each” principle using a dictionary of possible etymologies of the entity-objects contents, which can be placed also in the public networks, and which is constantly specified and updated in the automatic mode, where each noun is pre-assigned the most probable structure of the functional part of the predicate, which this noun is conditioned with, i.e., its etymology assigned hypothetically or obtained through some other research and recognized by users and the degree of this probability depends on the specific character of the abstract domains, as a correspondence is established at this step between the words of the input streams and the words that exist in the dictionary; thus the result of this comparison becomes the first approximation of the desired separation of the entity-objects, as well as obtaining a first approximation of the structures of their etymologies; and the words that mean the yet unknown-to-the dictionary entity-objects and classes of relationships, for further analysis are transferred into a separate group, and if the unknown-to-the-dictionary entity-objects are not found in the initial streams the logical analysis is over; all the further steps of the method claimed track down the etymological qualities of the entity-objects, unknown to the dictionary and offers some recommendations regarding some probable incorrect nouns and verbs usages, that can denote even some illogicalities in some certain abstract domains' sections operation, that is why, on identifying such illogicalities the user is presented with some relevant conclusions.

9. The method of claim 8, characterized in that the next step features the automated logical analysis of the entity-objects and relationships, which proved to be unknown to the dictionary of possible etymologies, and, above all, the unknown potential composite entity-objects are separated through the logical comparison of each of the unknown entity-objects with those that are formed of the repeating nouns and verbs from the initial stream by combining them into one component, i.e. multilateral post-relational entity-object, given there is a coincidence of the relationship class, i.e. the coincidence of verbs between various pairs, since it is due to multiple occurrence of nouns mentioned in several different connections, i.e. for several different verbs, the probability that these entity-objects belong to the group of the composite entity-objects, greatly increases, thus this approximation will not cause much incorrectness—it will be specified at the next steps, they also ignore the presence of indefinite entity-objects, having some logical contradictions, and artifacts in these pre-separated groups of entity-objects at this step.

10. The method of claim 9, characterized in that during the next step, the final phase of the automated logical analysis of the initial stream is carried out, for which the groups of those entity-objects and relationships are analyzed automatically, i.e. the unknown-to-the-possible-etymologies-dictionary entity-objects and relationships and that were left after the removal of potential composite entity-objects, and the unknown atomic entity-objects are separated using a single logical criterion, which lies in the fact that, in general, to identify any specific value of a natural attribute, i.e. not artificially assigned by the user, that is the attribute of the atomic entity-object, the name of the entity-object and the name of the attribute would be only sufficient, which is impossible in the case of a weak entity-object—the weakness lies in the fact that it is impossible to identify any value of any natural attribute of the weak nature of the entity-object without regard of its relationship with the one that functionally defines it, i.e., with the hierarchically older entity-object; thus the method at this step requires putting in some additional information, if it has not been included in the initial streams, relative to the natural attributes of each entity-objects, which are subject to analysis, as well as a few values of each of these attributes, moreover, since the automated logical analysis of this step is completed, each entity-object, left from the previous comparisons, acquires the status either of an atomic entity-object, either a weak or undefined, and the presence of artifacts at this step is ignored, and they also obtain one of these statuses.

11. The method of claim 10, characterized in that the indefinite entity-objects (those, having some controversial semantics) group not becoming empty, after the previous steps of the logical analysis of the initial stream of entity-objects and relationships, i.e. through logical analysis it is impossible to assign these entity-objects to the three categories, each of these controversial entity-objects is forcibly assigned the atomic status by the method, but necessarily designating this at the level of their cell identifier, adding some specialized member, responsible for this feature, to the unary identifier thus forming a separate subgroup of controversial entity-objects in the group of the atomic ones, so that some appropriate amendments can be made with further separation even during the warehouse operation, modifying its structure, if there is need.

12. The method of claim 11, characterized in that the next step features the final separation of the artifacts (i.e. entity-copies) from pre-selected group of entity-objects artifacts, for the purpose of which the automatic statistical comparison is performed, i.e. the comparison based on using the known procedures of the statistical analysis to identify the deterministic functional or correlational or regressive multi-valued dependencies between the data in the attributes of the entity-objects, as well as the tightness of these relationships, which can confirm or deny the direct coincidences of the attributes groups, as well as the disguised etymology and semantic structure of the contents received at the previous steps, in the event of, at this step, the direct coincidences between the names of the groups of attributes, as well as their values for different entity-objects, this fact is separately stated at the level of cell identifiers, which enables the user to figure out in terms of the issue of some redundant data storing; however, the situation where the names of the attributes that belong to different entity-objects are different, and their value, being for some reasons identical, will become obvious at the increased number of attributes' values, which also is reflected in structure of the cell.

13. The method of claim 12, characterized in that the next step features the refined approximation construction, i.e. the approximation of the separation of the composite entity-objects, for which it is taken into account that for the correctness of statistical analysis the whole set of values of all the attributes from all entity-objects of the abstract domains must conform to the single point in the abstract domains' lifetime, and the distance between adjacent time intervals should be sufficient for the emerging of a truly new state of the abstract domains, since if this condition is not met, the regularities might be incorrect; to meet this condition, a group of some attribute values, depending on time, is separated from the group of the values attributes that are independent of time, and if they do, then only on very considerable periods of time—their development and alterations may be neglected in comparison with other groups of attributes values, and, the attribute group, which practically does not depend on time, is separated to the group of entity-objects, that create the structure of the abstract domains, because the structure of a system depends on time more slowly, namely, its function, i.e. some “creation” of certain relationships between entity-objects; thus this stage features a group of entity-objects handling the specified approximation of the composite entity-objects approximation, i.e. the time-depending objects, while the other group receives the status of the set of the atomic, atomic-undefined and weak ones, because the initial stream got rid of artifacts at the previous steps, and this is reflected in the relevant cell identifiers; so that each composite entity-object from the newly received group is compared with a group of composite entity-objects that were left after the automated logical analysis, and, a criterion is used the process of the comparison that there appears a deterministic functional relation between the sum of values of each sample of the common set of attributes of ancestors and values of samples of any incidental, or even each attribute of the composite entity-objects, which is a sufficient criterion for the identification and separation of composite entity-objects; here, if there are some coincidences, while comparing potentially composite entity-objects obtained at the different steps of method, the cell identifiers remain unchanged, in the other case, two respective independent cell identifiers are formed within each of those potentially composite entity-objects, then recording this fact, and these entity-objects are given the status of undefined but potentially composite, which is verified at the next steps, or it requires some additional information.

14. The method of claim 13, characterized in that the next step features repeated and more visual automatic separation of the atomic from the weak entity-objects in the group where the atomic and weak entity-objects are selected thanks to two criteria that are used simultaneously: the first criterion is that in orders to identify any value of the natural attributes of the atomic entity-object it is sufficient to have only a name of the entity-object and an attribute's name that is impossible namely in case of weak entity-object, but such a comparison, at this step, is carried out on the increased quantity of data; the second criterion of the method has a purely mathematical origin and is all about that between attributes of a descendant and the total attributes of all ancestors a functional dependence is observed, and hence a deterministic relationship that allows you to monitor not only the fact of weakness, but also to specify the relationships members to some older entity-objects, which is reflected in the structure of their cell identifiers; and, if the connection from a descendant to an ancestor is established unequivocally, checking on the presence or absence of unambiguous feedback from an ancestor to many descendents is only possible thanks to interpolation of the attributes' values of all the descendants of the next level, i.e. the transformation of the set of these values into a mathematical function and inspection of deterministic dependence at a segment in the vicinity of attribute of any specific descendant; the feedback is displayed in the structure of the entity-object cell identifier; nevertheless, if it turns out, that some of the entity-objects, classified as the weak ones, were assigned to it by mistake, then the etymology of each undefined entity-object will be defined at the next step of the method claimed, as it is at this step, that the error can arise only because the etymology of the weak and the composite entity-objects are similar; an entity-object slow depending on the time may result in its erroneous separation in that case; nevertheless, an option, that the atomic entity-object considerably depends on the time and why it got into a group of composite entity-objects by a mistake is impossible, and therefore will also be determined at the next step.

15. The method of claim 14, characterized in that the framework of the total set of data relationships is built as a template for the further specifying of not only the nature and membership of composite entity-objects to the group, but also for the final restoration of the concrete structure and each member in the etymology of each composite entity-object, when the use of methods of comparison in accordance with the preceding paragraphs is not sufficient, based on the set of atomic and weak entity-objects received from the previous steps of the method; and within this total set further iterations are fulfilled for comparing the potential composite entity-objects with template ones as follows:
A basic set of entity-objects is formed on the basis of atomic groups and weak entity-objects: another subgroup of virtually atomic entity-objects is added to a selected group of atomic entity-objects, which are obtained by adding the separate unary identifier to the identifiers of the weak entity-objects, as if it were an atomic one, thus creating the initial set of simple unary identifiers;
A single domain of the memory to allocate the warehouse elements identifier is placed into the warehouse for each unary identifier of each entity-object from the basic set, this identifier's structure being strictly unary; an initial set of simple singular domains is created in the memory, and the identifiers of the weak entity-objects can be marked optionally. Nevertheless, the way to install those marks may be arbitrary, or none whatever;
the framework template of standard composite entity-objects is synthesized in the warehouse, for the purpose of which the combinations of Cartesian multiplications of the above-mentioned singular identifiers to each other on the principle “each by each”, through which the system of domains with multi-ary identifiers is generated, structure of each of them strictly corresponds to the structure of the functional part of the respective synthesized compound predicates; with the structure of some of them corresponds to the structure of composite entity-objects from the third group of the method; after that semantically joined domains are filled with some relevant data in the synchronized way; thus receiving a complete set of semantic connections of composite domains, which means that in this synthesized set every K-ary composite domains were generated with Cartesian product of K copies of the atomic entity-objects, i.e. K-th sample from the basic set, which synthesizes the full framework of the named structured cells for distribution of data from the attributes of the composite entity-objects from the initial stream; while the total number of such composite domains with some identified cells, and further some data tables equal the number of sets of powerset, i.e. the combination of sets of all subsets; at this stage, the values of all the attributes, received from the initial stream of the attributes of abstract domains' description are placed into the cells of the synthesized framework-template taking into account the detected etymologies, i.e., the cell identifiers;
Thanks to the procedures of the statistical analysis using some specific data values a final verification is performed, i.e. the verification of groups of the attributes of atomic, composite and weak entity-objects from the initial stream, as well as the atomic and composite cell identifiers for a mutual compatibility, and the method assumes the possibility of multiple specification of this compatibility by applying a repeated procedure of successive approximations and multiple modification of the basic set and corresponding framework-template, which will eventually lead to a complete coincidence between the etymology of all the entity-objects from the initial stream with the etymologies of the artificially synthesized ones on the framework.

16. The method of claim 15, characterized in that an external library has been built, which is replenished with new subordinate ways of both logical and statistical analysis, designed by users, as well as new criteria for comparison, as the list of subordinate methods of comparing data between each other is not restricted, nor is restricted the sequence of performing the above-mentioned procedures; however, the constant operation, replenishing the dictionaries of probable etymologies, which may be significantly incomplete at the initial stages of its existence, minimizes the need for an automated logical or statistical analysis of the initial streams.

17. The method of claim 16, characterized in that the next step features the data location into the warehouse on completion of the statistical analysis on a full framework-template of the entity-objects and thus completion the data separation, for which a special procedure lets it to be taken into account some artifacts: at the first step of the data distribution it is primarily taken into account all the possible partial copies of the basic set of entity-objects, forming masks of these entity-objects, and then, on the next steps, all relationships between the groups of these masks of the entity-objects in the abstract domains are modeled, for which for each group of masks a few sections of memory are allocated a space in the warehouse to place the warehouse elements, i.e. they reserve a domain-mask with the respective unary cell identifier in each section of the memory, thus creating an expanded set of the sections of memory, so that the basic set of entity-objects gets also greatly extended, and the number of domain-masks being placed there, is equal to the number of masks of each entity-object; in this case, the domain-masks assign all entity-objects to the masks, i.e. the masks of those entity-objects that have a hierarchical dependency on their information ancestors, i.e., the weak entity-objects, with it, because, in general, weak entity-objects are dependent on the chain of entity-objects, where each entity-member, in its turn, is also weak, except the most senior entity-object in the chain, the domain-masks are designated as if this dependence does not exist, i.e. ignoring the hierarchical dependence, it will not lead to the loss of such relationships, since the method's algorithm provides a further accounting for all types of relationships between domain-masks, and hence the initial hierarchical relationships between the entity-objects.

18. The method of claim 1, or 17, characterized in that the warehouse scheme is built in the digital memory in accordance with combinations of Cartesian products of all domain-masks among themselves on the “each on each” principle, while the total number S(t) of groups of attributes being placed accounting for the set of domain-masks of each entity-object and the dependence of this parameter on the number of time period, the total number is given by:
$$S ( t ) = {\sum }_{K = 1}^{NN ( t )} \frac{NN ( t ) !}{K ! ( NN ( t ) - K ) !} = {2}^{NN ( t )} - 1$$
where K is the current arity of the relationships of groups of domain-masks, and NN(t) is the total number of domain-masks, which depends on t, which is the number of the time period of the relevance of warehouse structures, during which this structure will not experience modifications, and the total number of domain-masks is determined by the formula:
$$NN ( t ) = {\sum }_{i = 1}^{N ( t )} {\sum }_{j = 1}^{M ( i , t )} α ( i , j , t ) ,$$
where, in turn, a(i, j, t) is a sign of the relevance of a domain-mask, a formal array of integers, each of which is determined by a set of indices (i, j, t) and within the method claimed is either assumed to equal to zero, which represents the annulation of the domain-mask, or one which represents the relevance of a domain-mask, t is the number of the period of relevance time, i is the index that represents the number of an entity-object, N(t) is the total number of entity-objects in the time interval under the number of t, M (i, t) is the number of domain-masks of each i-th entity-object in the time interval at number t, and the number of domain-masks can not be arbitrary or separated from the quantity of domain-masks of other entity-objects, because while forming some binary, ternary or higher arity relationships on the part of each participating entity-object from the basic set in this context, there should be enough domain-masks for participation in the relationships, which means that being in the warehouse the domains masks are updated or annulated parallel with the updating or cancellation of the respective relationships, i.e., the roles, which involve some specific groups of entity-objects, j is the index that represents the number of a domain-mask, the total amount of which for the i-th entity-object is represented with the inner sum, and the outer sum represents the total number of domain-masks, after which for a table way of storing method they synchronously fill the momentarily obtained semantically compatible relational tables with the prospective data, and semantically non-compatible ones are omitted.

19. The method of claim 18, characterized in that it provides a specific number address in the structure of the memory cell that hosts the domain-mask, a structured identifier of the cell, which may have a common basic name for all domain-masks, as well as pass-through three-dimensional (i, j, t) indexation, which uniquely relates to each domain-mask of each entity-object, that is, each index is responsible for its basic factor of the method, where the indices denote: t—the number of the length of time of the relevance of the current state of the t-th modification of the set of all (i, j)-th data tables for tabular presentation, i=1, N (t) is the number of each entity-object, N(t) is the total number of entity-objects in the time interval with number t, j=1, M(i, t) is the number of each domain-mask of the i-th entity-object in the time interval with number t; thus, the time interval that has number t, the warehouse scheme, i.e the scheme of the entire set of tables for the tabular distribution remains unchanged, ie, is not modified, and at the instance of time, having the number t+1, this same set is already getting a modification of its state; this method provides an option to assign and use any formal condition for the transition to the new code of the length of time of the relevance of the current state of the warehouse, which means to a new set of tables and corteges, and also allows you to build a temporally-layered data archive.

20. The method of claim 19, characterized in that for building of the distributed data warehouses, located on physically different servers, each attribute of a logical model, which in the physical model is a digital data, is placed in the digital memory using a structured identifier of the cell as a physical code of addressing to the data, i.e., the same surrogate key of the logical model, which, for example, is a relational identifier for the relational data model, with structured cell identifier is the bearer of the method's advantages, offering an option for distributing the groups of data on physically different servers without losses of relationships, that significantly increases the flexibility of warehouse structures.

21. The method of claim 20, characterized in that for the storing of those data, which would feature high-speed implementation of both relational and object-oriented queries, each atomic attribute of each entity-object, i.e. each atomic data set, which combines one-place part of the generally multi-place predicate into the attribute of this entity-object, is endowed with its own unique structured identifier, whose the common part of the structure is identical to the structure of the etymology of the entity-object, i.e. structure of which is identical with the structure of the functional part of the multi-place predicate, and the latter, unique member of the identifier corresponds to the data values of this attribute, which allows you to perform queries using the method of indexing the identifier in accordance with its structure; this procedure significantly increases the response speed and, in its turn, enables one to combine the properties of the table and non-table forms of storing, which is obtained by means of non-table associating the data sets into the attributes of the entity-objects in accordance with the identifiers generic in form and structure, which, in its turn helps develop the data scheme in the warehouse aimed at combining the relational and non-relational ways of modeling and data distribution, for example, object-oriented way, and the method claimed offers the option of either separated and parallel processing of each data independently from one another, or group-processing of several associated data groups both dependently and independently of one another, moreover, there is no need for strict compliance of each datum of the general attribute in type and size, as is required, for example, in the relational way of distribution.
